(19) United States
(12) Patent Application Publication
(10) Pub. No.: US 2025/0173500 A1
(43) Pub. Date: May 29, 2025

(54) METHODS, APPARATUSES AND COMPUTER PROGRAM PRODUCTS FOR CONTEXTUALLY AWARE DEBIASING

(71) Applicant: Optum, Inc., Minnetonka, MN (US)

(72) Inventors: Siddhant Srivastava, Lucknow (IN); Tanmey Rawal, Panchkula (IN); Ankur Gulati, Faridabad (IN); Vinay Gupta, Hyderabad (IN); Vivek Prasann, Hyderabad (IN); Ayush Kumar Tiwari, Dsitrict Aligarh (IN)

(21) Appl. No.: 18/523,312

(22) Filed: Nov. 29, 2023

(51) Int. Cl. G06F 40/166; G06F 40/30; G06V 30/413; G06V 30/414

(52) U.S. Cl. CPC G06F 40/166; G06F 40/30; G06V 30/413; G06V 30/414

(57) ABSTRACT

Various embodiments of the present disclosure provide contextually aware debiasing techniques for debiasing a document. Some embodiments generate one or more document segments that each comprise a sequence of terms from a syntactic debiased document, identify one or more candidate semantic bias terms from a document segment of the one or more document segments based on a semantic bias corpus in response to the identification of the one or more candidate semantic bias terms, generate, using a classification model, a bias classification for the document segment, and in response to a positive bias classification, provide, using a semantic debiasing model, one or more replacement tokens for the one or more candidate semantic bias terms.

### BACKGROUND

Various embodiments of the present disclosure address technical challenges related to debiasing text data given limitations of existing debiasing techniques. Traditionally, a word from a document is compared to a list of bias words, and, if found, replaced without considering the context in which the word is used in the document. This replacement of a word without consideration of the context of use of the word reduces the performance (e.g., accuracy, completeness, speed, efficiency, computing power, etc.) of traditional debiasing techniques as the same word may have different meanings in different contexts. Various embodiments of the present disclosure make important contributions to existing debiasing techniques by addressing these technical challenges.

### BRIEF SUMMARY

Various embodiments of the present disclosure disclose contextually aware debiasing techniques for improved and comprehensive computer-based natural language interpretation and debiasing. Traditional language processing techniques leverage rule-based methods for identifying predefined terms and replacing them with other predefined alternatives without considering the context of use of the identified term. Some of the techniques of the present disclosure improve upon such techniques by leveraging a machine learning pipeline configured to classify the context in which a term is used to inform bias predictions. In this manner, some of the techniques of the present disclosure may improve upon traditional language processing techniques, such as rule-based bias detection, by generating contextually aware bias predictions. These same predictions may be leveraged to generate term recommendations that, like the predictions, are tailored to the context in which a bias word may be replaced. By doing so, some techniques of the present disclosure improve the accuracy, efficiency, reliability, and relevance of conventional debiasing engines.

In some embodiments, a computer-implemented method includes generating, by one or more processors, one or more document segments that each comprise a sequence of terms from a syntactic debiased document; identifying, by the one or more processors, one or more candidate semantic bias terms from a document segment of the one or more document segments based on a semantic bias corpus; in response to the identification of the one or more candidate semantic bias terms, generating, by the one or more processors and using a classification model, a bias classification for the document segment; and in response to a positive bias classification, providing, by the one or more processors and using a semantic debiasing model, one or more replacement tokens for the one or more candidate semantic bias terms.

In some embodiments, a computing system includes a memory and one or more processors communicatively coupled to the memory. The one or more processors configured to generate one or more document segments that each comprise a sequence of terms from a syntactic debiased document; identify one or more candidate semantic bias terms from a document segment of the one or more document segments based on a semantic bias corpus; in response to the identification of the one or more candidate semantic bias terms, generate, using a classification model, a bias classification for the document segment; and in response to a positive bias classification, provide, using a semantic debiasing model, one or more replacement tokens for the one or more candidate semantic bias terms.

In some embodiments, one or more non-transitory computer-readable storage media include instructions that, when executed by one or more processors, cause the one or more processors to generate one or more document segments that each comprise a sequence of terms from a syntactic debiased document; identify one or more candidate semantic bias terms from a document segment of the one or more document segments based on a semantic bias corpus; in response to the identification of the one or more candidate semantic bias terms, generate, using a classification model, a bias classification for the document segment; and in response to a positive bias classification, provide, using a semantic debiasing model, one or more replacement tokens for the one or more candidate semantic bias terms.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 is a data flow diagram showing example stages of a contextually aware debiasing technique in accordance with some embodiments described herein.

FIG. 4 is a dataflow diagram of a first stage of a contextually aware debiasing technique in accordance with some embodiments discussed herein.

FIG. 5A depicts an operational example of an input document in accordance with some embodiments discussed herein.

FIG. 5B depicts an operational example of a grammar corrected document in accordance with some embodiments discussed herein.

FIG. 5C depicts an operational example of a syntactic debiased document in accordance with some embodiments discussed herein.

FIG. 6 is a dataflow diagram of a second stage of a contextually aware debiasing technique in accordance with some embodiments discussed herein.

FIG. 7A depicts an operational example of a syntactic debiased document showing bias classification in accordance with some embodiments discussed herein.

FIG. 7B depicts an operational example of masked tokens in accordance with some embodiments discussed herein.

FIG. 7C depicts an operational example of output document of a contextually aware debiasing technique in accordance with some embodiments discussed herein.

FIG. 7D depicts an example user interface displaying a debiased document in accordance with some embodiments discussed herein.

FIG. 8 is a flow chart showing an example of a process for debiasing a document in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based at least in part only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

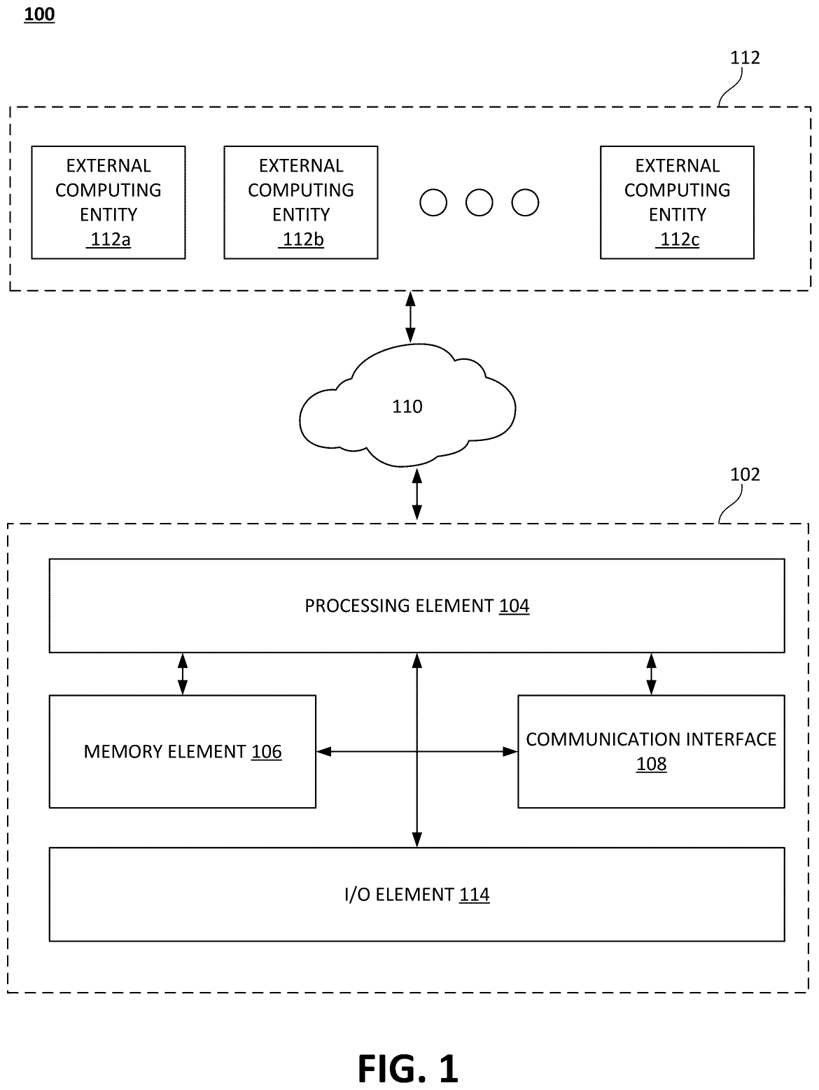

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., multi-stage contextually aware debiasing techniques, natural language processing techniques, preprocessing techniques, and/or the like) described herein.

The external computing entities 112a-c , for example, may include and/or be associated with one or more data sources configured to receive, store, manage, and/or facilitate one or more data sources that is accessible to the predictive computing entities 102. The external computing entities 112a-c , for example, may provide access to the data to the predictive computing entity 102 through a plurality of different data sources. The external computing entities 112a-c , for example, may provide data to the predictive computing entity 102 which may be leveraged to generate training dataset(s) and/or bias corpus.

By way of example, the predictive computing entity 102 may include a data processing system that is configured to leverage data from the external computing entities 112a-c and/or one or more other data sources to train one or more machine learning models over a training dataset. The external computing entities 112a-c , for example, may be associated with one or more data repositories, cloud platforms, compute nodes, organizations, and/or the like, that may be individually and/or collectively leveraged by the predictive computing entity 102 to obtain and aggregate data regarding various types of bias.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like, may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

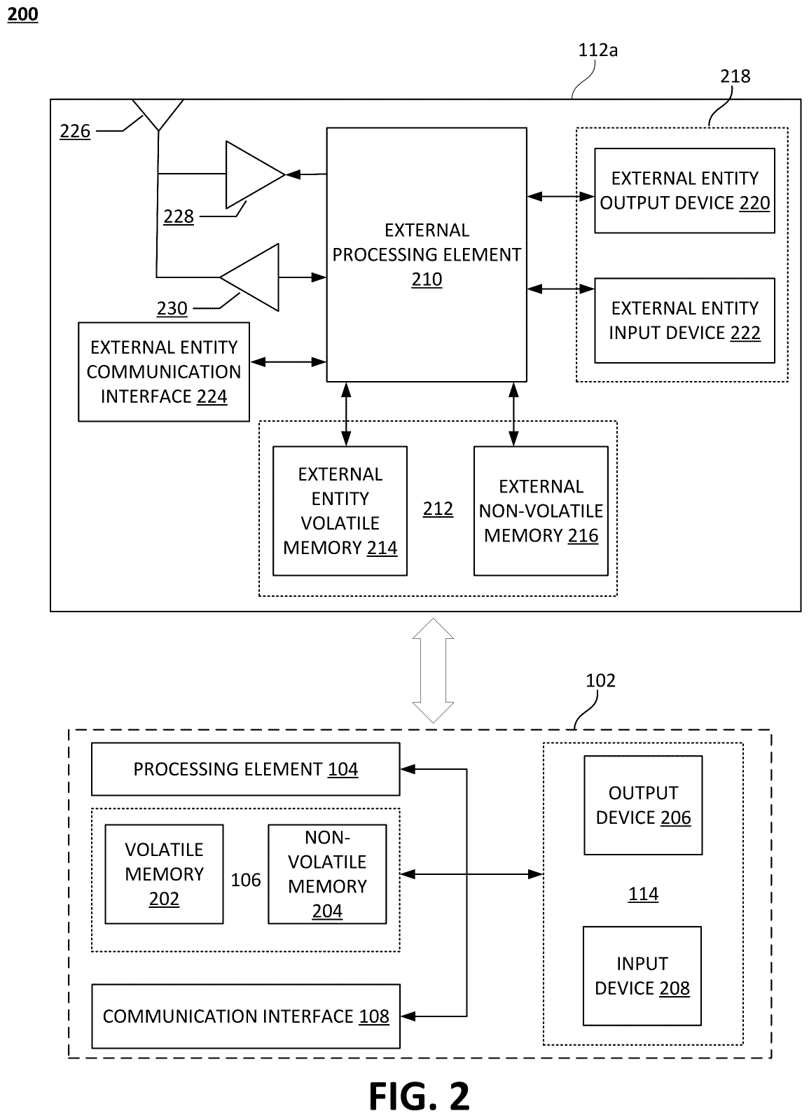

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include one or more external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “document” may refer to a data entity that describes a collection of text data (e.g., one or more words, sentences, phrases, and/or the like). Examples of a document include a job description, a policy manual, and/or the like. In some examples, a document may include one or more bias terms, where an objective of one or more natural language processing operations may be to identify the bias terms and provide non-bias replacement terms.

In some embodiments, the term “text preprocessing operation” may refer to a data entity that describes one or more actions configured to prepare text data for natural language processing. A text preprocessing operation may facilitate machine interpretation, analysis, processing, and/or the like of text data. By way of example, a text preprocessing operation may include text cleaning to remove stop words, special characters (e.g., bullet points, punctuations, emoticons, Unicode characters, and/or the like), and/or the like from text data present in a document. By way of example, text preprocessing operation may be performed using a set of regular expressions. For example, a set of regular expressions may be leveraged to identify, remove, and/or replace stop words, special characters, and/or the like. The identified stop words and/or special characters, for example, may be replaced with anchors to enable further processing of the text data.

In some embodiments, the term “grammar corrected document” may refer to a document previously processed to correct grammatical errors (if any) in the document. In some examples, a grammar corrected document may be output of a grammar correction model. For example, a grammar correction model may process a document to identify and correct grammatical errors (if any) within the document.

In some embodiments, the term “document segment” may refer to a sequence of terms from a document. The sequence of terms, for example, may include a phrase, a sentence, a topic, and/or the like from the document. In some examples, the sequence of terms may form a sentence of the document. For instance, a plurality of document segments may be generated from a document that may include at least one segment for each sentence from the document. In this way, a document may be decomposed into a plurality of sentence-level segments that may be analyzed individually and/or in one or more combinations using some of the techniques of the present disclosure.

In some embodiments, the term “segmenting operation” may refer to a data entity that describes one or more actions configured to segment a document into one or more segments (e.g., document segments) that each include a sequence of terms. In some examples, a segmenting model may be previously trained to segment a document into one or more document segments.

In some embodiments, the term “segmenting model” may refer to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the segmenting model may be configured, trained, and/or the like to process a document to segment the document into one or more segments (e.g., document segments). The segmenting model may include one or more of any type of machine learning model including one or more supervised, unsupervised, semi-supervised, reinforcement learning models, and/or the like. In some examples, the segmenting model may be previously trained using one or more supervised machine learning techniques. In some examples, the segmenting model includes a rules-based model configured to apply one or more rules to generate document segments. In some examples, the segmenting model may include multiple models configured to perform one or more different stages of a segmenting operation.

In some embodiments, “tokenization operation” may refer to a data entity that describes one or more actions configured to segment text data into one or more tokens. The one or more tokens, for example, may include a phrase, a word, and/or the like. In some examples, the one or more tokens may include a sequence of word tokens that form a document segment. For example, a document segment may be decomposed into a plurality of word tokens that may be analyzed individually and/or in one or more combinations using some of the techniques of the present disclosure. In some embodiments, a tokenizer model may be utilized to segment a document segment into one or more tokens. In some examples, the tokenizer model may include a bidirectional encoder representation from transformers (BERT) tokenizer. By way of example, output of a tokenization operation performed on an example document segment “I live in New York” may include “I” word token, “live” word token, “in” word token, and/or “New York” word token.

In some embodiments, the term “speech tagging operation” may refer to a data entity that describes one or more actions configured to determine the grammatical group (e.g., part of speech such as noun, pronoun, adjective, verb, adverb, and/or the like) associated with a word token. For example, a speech tagging operation may include predicting the grammatical group for a word token based on context and assigning the grammatical group to the word token. By way of example, output of a speech tagging operation performed on the word tokens “I”, “live”, “in”, “New York” may include personal pronoun (PRP), verb (VBG), preposition (IN), and/or proper noun singular (NNP) respectively.

In some embodiments, the term “bias term” may refer to a data entity that is associated with and/or descriptive of a particular group, class, category, and/or the like. A bias term, for example, may be indicative of (e.g., include an indication of) a preference for a particular group, class, category, and/or the like over another. In some examples, a bias term may comprise a syntactic bias term or a semantic bias term.

In some embodiments, the term “syntactic bias term” may refer to a data entity that describes a word and/or a phrase that is constructed to refer to an entity based on the group, class, and/or category of the entity. For instance, a syntactic bias term may include binary pronouns, gender-specific nouns, and/or other gender-specific terms. Examples of a syntactic bias term include he, she, her, him, businesswoman, businessman, and/or the like.

In some embodiments, the term “semantic bias term” may refer to a data entity that describes a word and/or a phrase that is deemed a bias term in certain contexts. For example, a candidate semantic bias term may be deemed a bias term in one or more contexts while deemed a non-bias term in other contexts.

In some embodiments, the term “candidate semantic bias term” may refer to a data entity that describes a word and/or a phrase that may be associated with and/or descriptive of a particular group, class, and/or category based on one or more criteria. For example, a candidate semantic bias term may be deemed a semantic bias term or non-bias term based on semantic bias criteria. By way of example, in a job description domain, a candidate semantic bias term may be deemed a semantic bias term when used within a job description document in the context of a desired quality and may be deemed a non-bias term when used within a job description document in the context of a nature of job. For illustration, the term “decision” may be used in a nature of job context in the text data “Demonstrated hands-on experience in solving real-world problems using natural language processing and ML techniques like decision tree, SVM, and working with imbalanced data set.” In this regard, the term “decision” may be identified as a non-bias term in this particular text. Continuing with the illustration, the same term “decision” may be used in a desired quality context in the text data “Be comfortable with different work location, change in teams and and/or work shift, policies in regard to flexibility of work benefits and/or work environment, alternative work arrangements, and other decisions that may arise due to the changing business environment. In this regard, the term “decision” may be identified as a semantic bias term in this particular text.

In some embodiments, the term “syntactic debiasing criteria” may refer to a data entity that describes one or more rules for replacing syntactic bias terms. For example, a model may be trained to apply one or more rules to determine corresponding non-bias terms for syntactic bias terms. By way of example, the model may apply a set of one or more rules to a document to determine and replace binary pronouns identified in the document with their gender-neutral alternatives (e.g., He/She replaced with They, Himself/Herself replaced with Themselves, and/or the like). By way of example, the model may apply a set of one or more rules to a document to determine and replace gender-specific terms identified in the document with their gender-neutral alternatives.

In some embodiments, the term “syntactic bias corpus” may refer to a data entity that describes a collection of predefined syntactic bias terms. By way of example, a syntactic bias corpus may be aggregated from one or more data sources.

In some embodiments, a “syntactic bias detection model” may refer to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the syntactic bias detection model may be configured, trained, and/or the like to process text data to identify syntactic bias terms present in the text data, including, for example, binary pronouns and gender-specific nouns. The syntactic bias detection model may be configured, trained, and/or the like to iterate through a document segment to determine if a word token of the document segment comprises a syntactic bias term. In some examples, the syntactic bias detection model may be configured, trained, and/or the like to determine non-bias terms to replace identified syntactic bias terms. In some examples, the syntactic bias detection model may be configured, trained, and/or the like to replace identified syntactic bias terms with non-bias terms. For example, the syntactic bias detection model may be configured, trained, and/or the like to replace “he” with “they.” As another example, the syntactic bias detection model may be configured, trained, and/or the like to replace “hers” with “theirs.” The syntactic bias detection model may include one or more of any type of machine learning model including one or more supervised, unsupervised, semi-supervised, reinforcement learning models, and/or the like. In some examples, the syntactic bias detection model may be previously trained using one or more supervised machine learning techniques. In one example, the syntactic bias detection model includes a rules-based model configured to apply a set of one or more rules (e.g., syntactic debiasing criteria) to identify syntactic bias terms and/or replace an identified syntactic bias term with a corresponding non-bias term. In some examples, the syntactic bias detection model may include multiple models configured to perform one or more different stages of a syntactic debiasing task. For example, the syntactic bias detection model may include one or more models configured, trained, and/or the like to identify syntactic bias terms present in a document segment, and include one or more other models configured, trained, and/or the like to replace an identified syntactic bias term with a corresponding non-bias term. In some embodiments, the syntactic bias detection model may include one or more language models, such as BERT models, universal sentence encoder models, and/or the like

In some embodiments, the term “syntactic debiased document” may refer to data entity that describes a document previously processed to remove and/or replace syntactic bias term(s) previously present in the document.

In some embodiments, the term “text block” may refer to a data entity that describes a sequence of one or more document segments. For example, a text block may include a subset of document segments of a document. In some examples, a document may be segmented into one or more text blocks with each text block having substantially the same number of document segments. In some examples, a document may be segmented into one or more text blocks with at least a subset of the one or more text blocks having substantially the same number of document segments. In some examples, a document may be segmented into one or more text blocks with at least a subset of the one or more text blocks having different number of document segments. In some examples, one or more models may be leveraged to process a text block to identify and replace semantic bias terms with non-bias terms based on the context of the text block and/or associated document segments.

In some embodiments, the term “semantic bias corpus” may refer to a data entity that describes a collection of predefined candidate semantic bias terms. In some examples, a semantic bias corpus may be associated with a particular prediction domain. By way of example, a semantic bias corpus may be aggregated from one or more data sources associated with a particular prediction domain.

In some embodiments, the term “semantic bias detection model” may refer to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the semantic bias detection model may be configured, trained, and/or the like to process a document segment to determine if the document segment includes at least one candidate semantic bias term (e.g., candidate semantic biased document segments). The semantic bias detection model may include one or more of any type of machine learning model including one or more supervised, unsupervised, semi-supervised, reinforcement learning models, and/or the like. In some examples, the semantic bias detection model may be previously trained using one or more supervised machine learning techniques. In some examples, the semantic bias detection model includes a rules-based model configured to apply a set of one or more rules to identify candidate semantic bias terms present in a document segment. In some examples, the semantic bias detection model may be configured, trained, and/or the like to identify candidate semantic bias terms from a document segment based on a semantic bias corpus. For example, the semantic bias detection model may be configured, trained, and/or the like to iterate through a document segment to determine if a word token of the document segment is included in a semantic bias corpus. In some examples, the semantic bias detection model may include multiple models configured to perform one or more different stages of a bias identifying task. In some embodiments, the semantic bias detection model may include one or more language models, such as BERT models, universal sentence encoder models, and/or the like.

In some embodiments, the term “masked text block” may refer to a data entity that describes a text block with one or more masked tokens. A masked token, for example, may correspond to a semantic bias term. For example, a masking operation may be performed on a text block to mask semantic bias terms present in the text block. In some examples, one or more models may be leveraged to process a masked text block to provide replacement token(s) for each of one or more masked tokens in the masked text block.

In some embodiments, the term “masking operation” may refer to a data entity that describes one or more actions configured to omit, remove, filter, and/or the like one or more terms from a document. In some examples, a masking operation may be performed on a text block to omit, remove, and/or the like semantic bias terms from one or more document segments of the text block that includes at least one semantic bias term.

In some embodiments, the term “classification model” may refer to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. For instance, a classification model may include a language model that is configured, trained, and/or the like to process a document segment to generate a bias classification for the document segment. In some examples, a language model may include a machine learning model including one or more supervised, unsupervised, semi-supervised, reinforcement learning models, and/or the like. In some examples, the classification model may include multiple models configured to perform one or more different stages of a classification process.

In some examples, the classification model may include a binary classifier previously trained through one or more supervised training techniques. For instance, the classification model may include a natural language processor (NLP) model, such as a BERT model, universal sentence encoder models, deep learning models, and/or the like, configured, trained, and/or the like to generate a bias classification for a document segment. For example, the classification model may include a BERT model trained as a classifier to process a natural language sentence having one or more candidate semantic bias terms to generate a bias classification for the sentence based on semantic bias criteria. The classification model, for example, may be trained (e.g., via back-propagation of errors, etc.) using a labeled training dataset including a plurality of training document segments (e.g., sentences from historical and/or synthetic documents) with corresponding bias classifications. The classification model may be configured for a particular prediction domain by training the model using labeled training data from the particular prediction domain. By way of example, in a job description domain, the classification model may be trained to generate a bias classification for a document segment using training document segments from one or more historical and/or synthetic job descriptions.

In some examples, the bias classification may include a positive and/or negative bias classification that is based on semantic bias criteria. The semantic bias criteria may define one or more semantic contexts for a document segment and/or whether each of the one or more semantic contexts corresponds to a positive and/or negative bias classification. By way of example, the classification model may be previously trained to classify a document segment into one of the one or more semantic contexts and based on the semantic bias criteria, to generate a bias classification for the document segment.

In some examples, the semantic bias criteria may be based on a prediction domain. For example, the semantic bias criteria may define one or more semantic contexts that describe whether a document segment is associated with a non-biased context or a biased context depending on the prediction domain. By way of example, in a job description domain, a first semantic context may include “desired quality” context in which a candidate semantic bias term may be used in a biased manner. In such a case, a positive bias classification may be output for a document segment classified as a “desired quality” context. In addition, or alternatively, in the job description domain, a second semantic context may include “nature of job” context in which a candidate semantic bias term may be used in an unbiased manner. In such a case, a negative bias classification may be output for a document segment classified as a “nature of job” context. The classification model may be trained to classify a document segment as a positive bias classification where the document segment includes at least one semantic bias term used in the context of desired quality. For example, in a job description domain, the classification model may be trained to classify a candidate semantic biased document segment as a negative bias classification where none of the candidate semantic bias terms from the document segment is used in the context of desired quality. In some examples, the classification model may be previously trained using one or more supervised machine learning techniques and a training dataset associated with a particular prediction domain. By way of example, in a job description domain, the training dataset may include a plurality of labeled job descriptions. For example, each sentence from a job description having at least one candidate semantic bias term may be labeled as associated with “desired quality” context or “nature of job” context. In such example, a “desired quality” context may be indicative (e.g., include an indication of) of semantic bias, while “nature of job” context may be indicative (e.g., include an indication of) of non-bias.

In some embodiments, the term “bias classification” may refer to a data entity that describes output of a classification model. For example, a bias classification may be generated for a document segment utilizing a classification model. In some examples, a bias classification may be a positive bias classification (e.g., semantic bias classification) and/or a negative bias classification (e.g., non-semantic bias classification).

In some embodiments, the term “semantic bias criteria” may refer to a data entity that describes one or more conditions for determining whether text data is semantically biased. In some examples, the bias criteria may define one or more semantic contexts for a document segment and/or whether each of the one or more semantic contexts corresponds to a positive and/or negative bias classification.

In some embodiments, the term “candidate semantic biased document segment” may refer to a data entity that describes a document segment that includes at least one candidate semantic bias term.

In some embodiments, the term “semantic debiasing model” is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the semantic debiasing model may be configured, trained, and/or the like to process masked text data (e.g., masked text block) to generate one or more candidate replacement tokens for masked token(s). The semantic debiasing model may include one or more of any type of machine learning model including one or more supervised, unsupervised, semi-supervised, reinforcement learning models, and/or the like. In some examples, the semantic debiasing model may be previously trained using one or more supervised machine learning techniques. In some examples, the semantic debiasing model may include multiple models configured to perform one or more different stages of a token recommendation task. In some embodiments, the semantic debiasing model may include one or more language models, such as BERT models, universal sentence encoder models, and/or the like. In one example, the semantic debiasing model includes a BERT-based model pre-trained based on text data associated with the prediction domain to, for example, align the BERT-based model with the verbiage and/or nuances of text data associated with the prediction domain. For example, in a job description domain, the semantic debiasing model may include a BERT-based model pre-trained based on a plurality of job description documents to align the BERT-based model with the verbiage and/or nuances of text data often used in job descriptions. In some embodiments, the semantic debiasing model is configured, trained, and/or the like to predict the one or more candidate replacement tokens for a masked token based on context information of the text block and/or document segment that includes the masked token. In this manner, the semantic debiasing model captures and preserves the context of the text block and/or document segment.

In some embodiments, the term “candidate replacement token” may refer to a data entity that describes a potential alternative term for a bias term. For example, a candidate replacement token may include a potential alternative for a semantic bias term.

In some embodiments, the term “replacement token” may refer to a data entity that describes a non-bias term representing an alternative for a bias term. For example, a replacement token may be provided as an alternative for a semantic bias term.

In some embodiments, the term “natural language model” refers to a data entity that describes parameters, hyper-parameters, and/or defined operations of a rules-based, statistical, and/or machine learning model (e.g., model including at least one of one or more rule-based layers, one or more layers that depend on trained parameters, coefficients, and/or the like). For instance, a natural language model may include a language model that is configured, trained, and/or the like to process natural language text to generate an output. In some examples, a natural language model may include a machine learning model including one or more supervised, unsupervised, semi-supervised, reinforcement learning models, and/or the like. In some examples, a natural language model may include multiple models configured to perform one or more different stages of a natural language interpretation process. As one example, a natural language model may include a natural language processor (NLP) configured to extract entity-relationship data from natural language text. The NLP may include any type of natural language processor including, as examples, support vector machines, Bayesian networks, maximum entropies, conditional random fields, neural networks, and/or the like.

### IV. Overview

Some embodiments of the present disclosure present contextually aware debiasing techniques that improve traditional debiasing techniques by intelligently processing text data to generate optimized debiased text data. The contextually aware debiasing techniques may be leveraged to identify and replace both syntactic and semantic bias term(s) present in a document. Upon receiving a document comprising text data, some embodiments of the present disclosure may leverage one or more data processing operations to generate a syntactic debiased document. Some embodiments of the present disclosure may segment the syntactic debiased document into one or more document segments that may be individually and/or collectively analyzed to identify candidate semantic bias term(s) present in the document. Some embodiments of the present disclosure may generate a bias classification for a candidate semantic bias term based on contextual information derived from the segment of the document in which the candidate semantic bias term is identified. The bias classification may be leveraged to determine if a candidate semantic bias term qualifies as a semantic bias term and/or to classify the document segment in which the candidate semantic bias term is identified. One or more data processing operations may be applied to identify and provide contextually aware non-bias term(s) for identified semantic bias term(s). In this manner, using some of the techniques of the present disclosure, a document may be accurately debiased based on the context of the document, which improves the accuracy, reliability, and relevance of debiasing operations performed by traditional computer-based techniques. Ultimately this reduces the computing expense, while improving the performance (e.g., accuracy, completeness, speed, efficiency, computing power) of existing debiasing techniques.

Example inventive and technological advantageous embodiments of the present disclosure include (i) language processing techniques specially configured to facilitate context aware text debiasing and (ii) debiasing techniques that leverage context information for identifying, replacing, and/or recommending debiasing terms. Other technical improvements and advantages may be realized by one of ordinary skill in the art.

### V. Example of System Operations

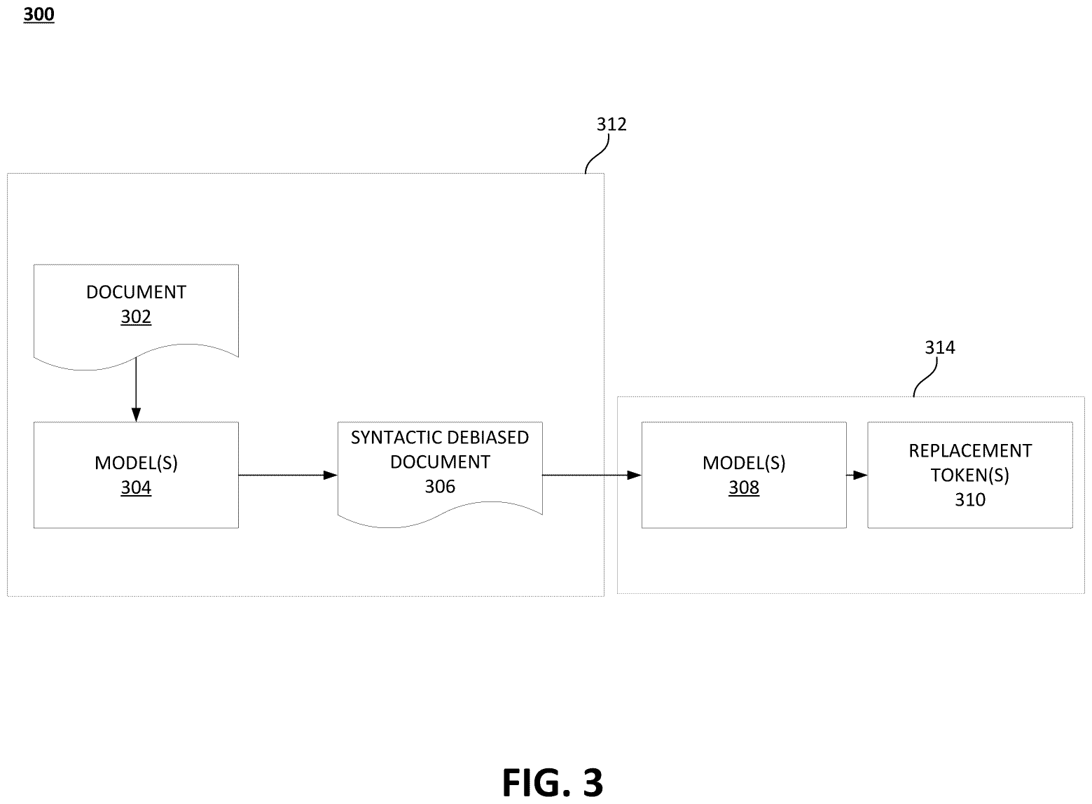

As indicated, various embodiments of the present disclosure make important technical contributions to machine learning text interpretation and debiasing techniques. In particular, systems and methods are disclosed herein that implement a multi-stage contextually aware debiasing technique configured to identify and replace both syntactic and semantic bias terms present in a document. As described with reference to FIG. 3, the multi-stage contextually aware debiasing technique provides technical improvements over traditional language processing techniques by leveraging a machine learning pipeline configured to classify the context in which a term is used to inform bias predictions. This, in turn, improves upon traditional language processing techniques, such as rule-based bias detection, by generating contextually aware bias predictions that may be leveraged to generate term recommendations tailored to the context in which a bias term may be replaced. By doing so, some techniques of the present disclosure improve the accuracy, efficiency, reliability, and relevance of conventional debiasing engines.

FIG. 3 is a data flow diagram 300 showing example stages of a multi-stage contextually aware debiasing technique in accordance with some embodiments described herein. The contextually aware debiasing technique is configured to debias a document 302 that may include one or more bias terms. In some embodiments, a document 302 is a data entity that describes a collection of text data (e.g., one or more words, sentences, phrases, and/or the like). Examples of a document 302 include a job description, a policy manual, and/or the like. In some examples, the document 302 may include one or more bias terms, where an objective of one or more natural language processing operations is to facilitate debiasing of the document 302.

In some embodiments, a bias term is a data entity that is associated with and/or descriptive of a particular group, class, category, and/or the like. A bias term, for example, may be indicative of a preference for a particular group, class, category, and/or the like over another. In some examples, a bias term may comprise a syntactic bias term or a semantic bias term.

In some embodiments, a syntactic bias term is a data entity that describes a word and/or a phrase that is constructed to refer to an entity based on the group, class, and/or category of the entity. For instance, a syntactic bias term may include binary pronouns, gender-specific nouns (e.g., gendered animate nouns), and/or other gender-specific terms. Examples of a syntactic bias term include he, she, her, him, businesswoman, businessman, and/or the like.

In some embodiments, a semantic bias term is a data entity that describes a word and/or a phrase that is deemed a bias term in certain contexts. For example, a candidate semantic bias term may be deemed a bias term in one or more contexts while deemed a non-bias term in other contexts. In some examples, a candidate semantic bias term may be determined to be a semantic bias term or non-bias term based on semantic bias criteria. By way of example, in a job description domain, a candidate semantic bias term may be deemed a semantic bias term when used within a job description document in the context of a desired quality and may be deemed a non-bias term when used within a job description document in the context of a nature of job. For illustration, the term “decision” may be used in a nature of job context in the text data “Demonstrated hands-on experience in solving real-world problems using natural language processing and ML techniques like decision tree, SVM, and working with imbalanced data set.” In this regard, the term “decision” may be identified as a non-bias term in this text. Continuing with the illustration, the same term “decision” may be used in a desired quality context in the text data “Be comfortable with different work location, change in teams and and/or work shift, policies in regard to flexibility of work benefits and/or work environment, alternative work arrangements, and other decisions that may arise due to the changing business environment. In this regard, the term “decision” may be identified as a semantic bias term in this text.

The data flow diagram 300 includes a first stage 312 and a second stage 314. During the first stage 312, a syntactic debiased document 306 may be generated for document 302 (e.g., input document). For example, during the first stage 312, syntactic bias term(s) identified in the document 302 may be replaced with corresponding non-bias term(s) to generate a syntactic debiased document 306. The contextually aware debiasing technique may leverage one or more models 304 during the first stage 312 to facilitate generation of the syntactic debiased document 306. During the second stage, one or more replacement tokens 310 (e.g., replacement terms) may be generated for semantic bias term(s) identified in the document 302. The contextually aware debiasing technique may leverage one or more models 308 during the second stage 314 to facilitate generation of the replacement token(s) 310. In some embodiments, the one or more models 304 and/or one or more models 308 may include language models.

In some examples, a language model may include a machine learning model including one or more supervised, unsupervised, semi-supervised, reinforcement learning models, and/or the like. In some examples, the language model may include multiple models configured to perform one or more different stages of a natural language processing configured to facilitate debiasing of a document comprising one or more bias terms. As one example, the language model may include an NLP model. The NLP model may include any type of NLP including, as examples, support vector machines, Bayesian networks, maximum entropies, condition al random fields, neural networks, and/or the like. By way of example, a language model may include a BERT model.

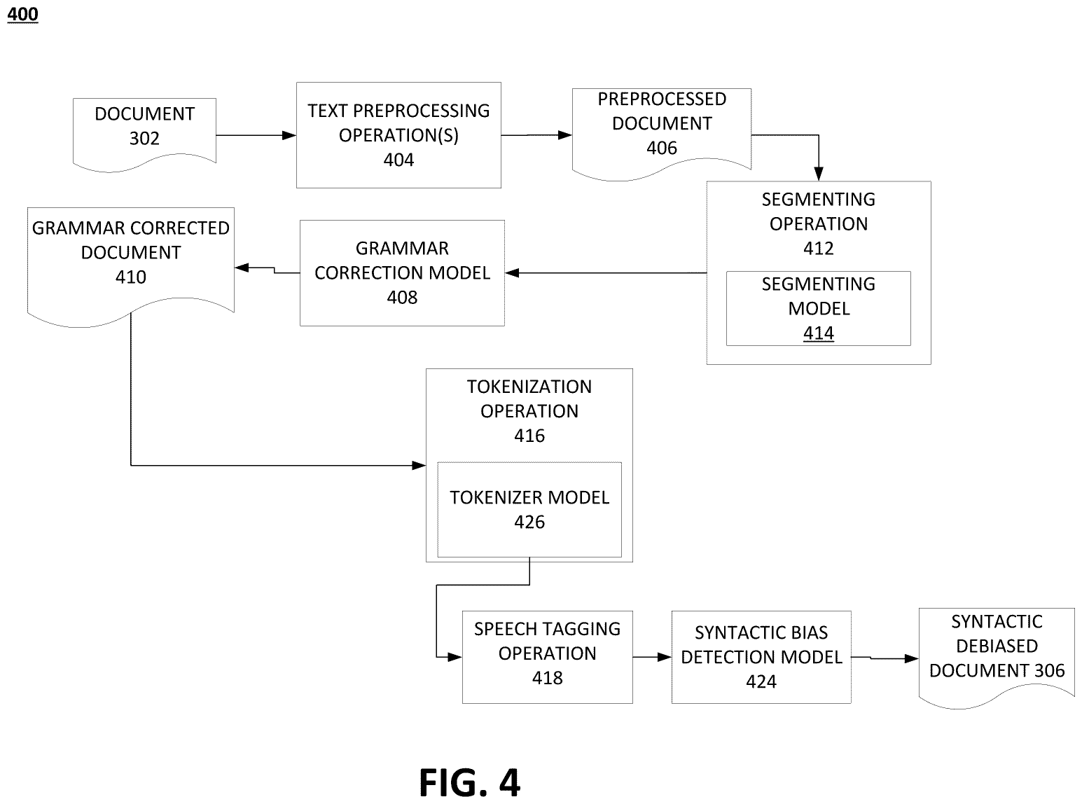

FIG. 4 is a dataflow diagram 400 of a first stage 312 of the contextually aware debiasing technique in accordance with some embodiments discussed herein. The dataflow diagram 400 illustrates a plurality of data and/or computing entities that may be collectively (and/or in one or more combinations) leveraged to generate a syntactic debiased document 306 for a document 302. In some embodiments, a text preprocessing operation 404 is first performed on the document 302 to generate a preprocessed document 406.

In some embodiments, a text preprocessing operation includes one or more actions configured to prepare text data for natural language processing. A text preprocessing operation may facilitate machine interpretation, analysis, processing, and/or the like of the text data present in the document 302. In some examples, the text preprocessing operation 404 includes text cleaning to remove stop words, special characters (e.g., bullet points, punctuations, emoticons, Unicode characters, and/or the like), and/or the like from text data present in the document 302. The text preprocessing operation 404 may be performed using any of a variety of techniques. By way of example, the text preprocessing operation 404 may be performed using regular expressions-based technique. For example, a set of regular expressions may be leveraged to identify, remove, and/or replace stop words, special characters, and/or the like from the document 302. In some embodiments, the identified stop words and/or special characters, are replaced with anchor(s). The anchor(s), for example, may enable further processing of the preprocessed document 406.

In some embodiments, a segmenting operation 412 is performed on the preprocessed document 406 to generate one or more document segments. In some embodiments, a segmenting operation is a data entity that describes one or more actions configured to segment a document into one or more segments (e.g., document segments) that each include a sequence of terms. The sequence of terms, for example, may include a phrase, a sentence, a topic, and/or the like from the document. In some examples, the sequence of terms may form a sentence of the document. For instance, a plurality of document segments may be generated from a document that may include at least one segment for each sentence from the document. In this way, a document, such as the preprocessed document 406, may be decomposed into a plurality of sentence-level segments that may be analyzed individually and/or in one or more combinations using some of the techniques of the present disclosure. In some embodiments, a segmenting model 414 may be utilized to segment the preprocessed document into one or more document segments.

In some embodiments, a grammar corrected document 410 is generated for the document 302. In some embodiments, a grammar corrected document is a document that has been processed to correct grammatical errors within the document. One or more techniques may be employed to generate the grammar corrected document 410. In some embodiments, the contextually aware debiasing technique leverages a grammar correction model 408 to generate the grammar corrected document 410.

In some embodiments, a grammar correction model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the grammar correction model 408 may be configured, trained, and/or the like to process a document 302 to identify grammatical errors (if any) present in the document 302. In some examples, the grammar correction model 408 may be configured, trained, and/or the like to process individual document segments from the document 302 separately to identify and/or correct grammatical errors (if any) associated within the respective document segment. The grammar correction model 408 may include one or more of any type of machine learning model including one or more supervised, unsupervised, semi-supervised, reinforcement learning models, and/or the like. In some examples, the grammar correction model 408 may be previously trained using one or more supervised machine learning techniques. In one example, the grammar correction model 408 includes a rules-based model configured to apply grammar rules to a document to generate a grammar corrected document. In some examples, the grammar correction model 408 may include multiple models configured to perform one or more different stages of a grammar correction task. In some embodiments, the grammar correction model 408 may include one or more language models, such as BERT models, universal sentence encoder models, and/or the like. In some examples, the grammar correction model includes a python language tool wrapper.

In some embodiments, a tokenization operation 416 is performed on the document segments after grammar correction to generate a sequence of one or more tokens. For example, a tokenization operation 416 may be performed on each document segment of the grammar corrected document 410 to generate a sequence of one or more tokens for each document segment. In some embodiments, a tokenization operation is a data entity that describes one or more actions configured to segment text data into one or more tokens. For instance, a tokenization operation may be configured to segment a document segment into one or more tokens. The one or more tokens, for example, may include a phrase, a word, and/or the like. In some embodiments, the one or more tokens include a sequence of word tokens that form the document segment. In this way, a document segment (for example, a sentence) may be decomposed into a plurality of word tokens that may be analyzed individually and/or in one or more combinations using some of the techniques of the present disclosure. In some embodiments, the contextually aware debiasing technique leverages a tokenizer model to segment a document segment into one or more tokens. In some examples, the tokenizer model may include a BERT tokenizer. By way of example, output of a tokenization operation performed on an example document segment “I live in New York” may include “I” word token, “live” word token, “in” word token, and/or “New York” word token.

In some embodiments, a speech tagging operation 418 is performed on the word tokens to determine the part of speech associated with a word token and/or assign a predicted part of speech tag to a word token. In some embodiments, a speech tagging operation is a data entity that describes one or more actions configured to determine the grammatical group (e.g., part of speech such as noun, pronoun, adjective, verb, adverb, and/or the like) associated with a word token. For example, a speech tagging operation 418 may include predicting the grammatical group for a word token based on context and assigning the grammatical group to the word token. For example, a speech tagging operation performed on the word tokens “I”, “live”, “in”, “New York” may output personal pronoun (PRP), verb (VBG), preposition (IN), and/or proper noun singular (NNP) respectively. In some embodiments, the speech tagging operation includes determining lemma and/or dependency parse tag for word tokens.

In some embodiments, the contextually aware debiasing technique includes iterating through each word token of a document segment to identify syntactic bias terms (e.g., binary pronouns, gender-specific nouns, and/or the like) based on the part of speech tag associated with the word token and/or a syntactic bias corpus (comprising a collection of predefined syntactic bias terms). In some embodiments, the contextually aware debiasing technique leverages a syntactic bias detection model 424 to identify and/or replace binary pronouns, gendered-specific nouns, and/or other syntactic bias terms from a document 302, for example, based on the part of speech tag associated with the syntactic bias term and/or based on the syntactic bias corpus.

In some embodiments, a syntactic bias detection model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the syntactic bias detection model 424 may be configured, trained, and/or the like to process a document segment to identify syntactic bias terms present in the document segment, including, for example, binary pronouns and gender-specific nouns. The syntactic bias detection model 424 may be configured, trained, and/or the like to iterate through a document segment to determine if a word token of the document segment comprises a syntactic bias term. In some examples, the syntactic bias detection model 424 may be configured, trained, and/or the like to determine non-bias terms to replace identified syntactic bias terms. In some examples, the syntactic bias detection model 424 may be configured, trained, and/or the like to replace identified syntactic bias terms with corresponding non-bias terms. For example, the syntactic bias detection model 424 may be configured, trained, and/or the like to replace “he” with “they.” As another example, the syntactic bias detection model 424 may be configured, trained, and/or the like to replace “hers” with “theirs.” The syntactic bias detection model 424 may include one or more of any type of machine learning model including one or more supervised, unsupervised, semi-supervised, reinforcement learning models, and/or the like. In some examples, the syntactic bias detection model 424 may be previously trained using one or more supervised machine learning techniques. In one example, the syntactic bias detection model 424 includes a rules-based model configured to apply syntactic debiasing criteria comprising a set of one or more rules to identify syntactic bias terms and/or replace an identified syntactic bias term with a corresponding non-bias term. In some examples, the syntactic bias detection model 424 may include multiple models configured to perform one or more different stages of a syntactic debiasing task. For example, the syntactic bias detection model may include one or more models configured, trained, and/or the like to identify syntactic bias terms present in a document segment, and include one or more other models configured, trained, and/or the like to replace an identified syntactic bias term with a corresponding non-bias term. In some embodiments, the syntactic bias detection model 424 may include one or more language models, such as BERT models, universal sentence encoder models, and/or the like.

In this regard, in some embodiments, the contextually aware debiasing technique includes iterating through each word in a document segment using a syntactic bias detection model 424 to replace an identified syntactic bias term with its corresponding non-bias term. In some embodiments, the part of speech tags and/or dependency parse tag associated with a word is utilized to disambiguate between one-many transformations.

In some embodiments, after replacing the identified syntactic bias terms from the document 302 with corresponding non-bias terms, a grammar verification operation is optionally performed. The grammar verification operation, for example, may include identifying subject-verb agreement errors (if any) in a document segment and correcting the identified subject-verb agreement errors based on the part of speech tag and/or dependency parse tag for the word tokens of the document segment.

In some embodiments, the contextually aware debiasing technique is configured to output a syntactic debiased document 306 at the first stage 312 based on performing one or more of the operations described above.

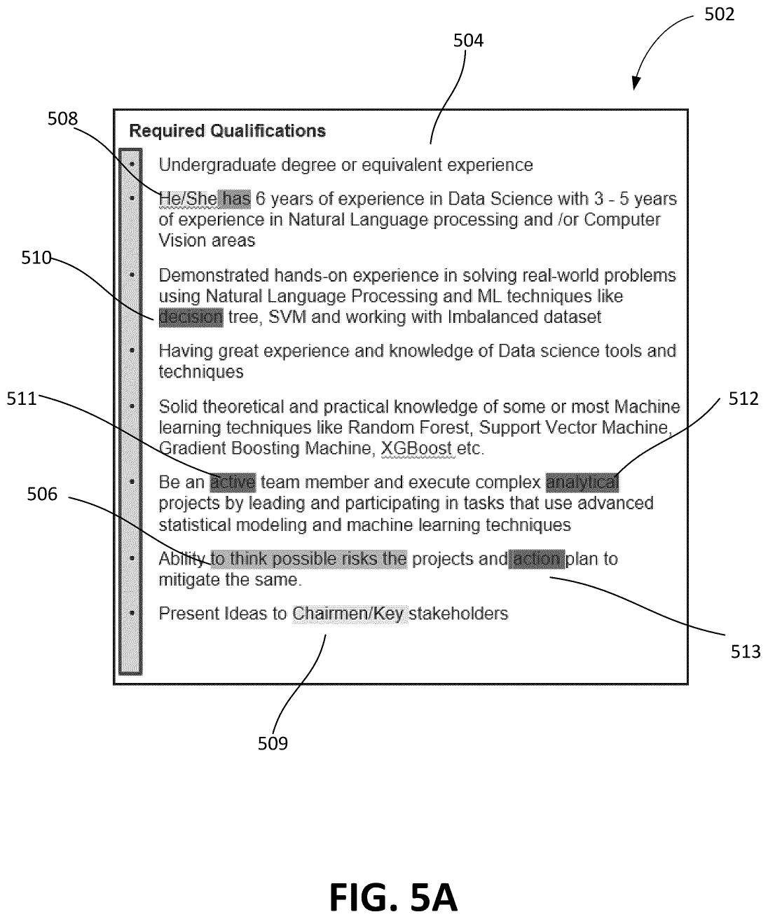

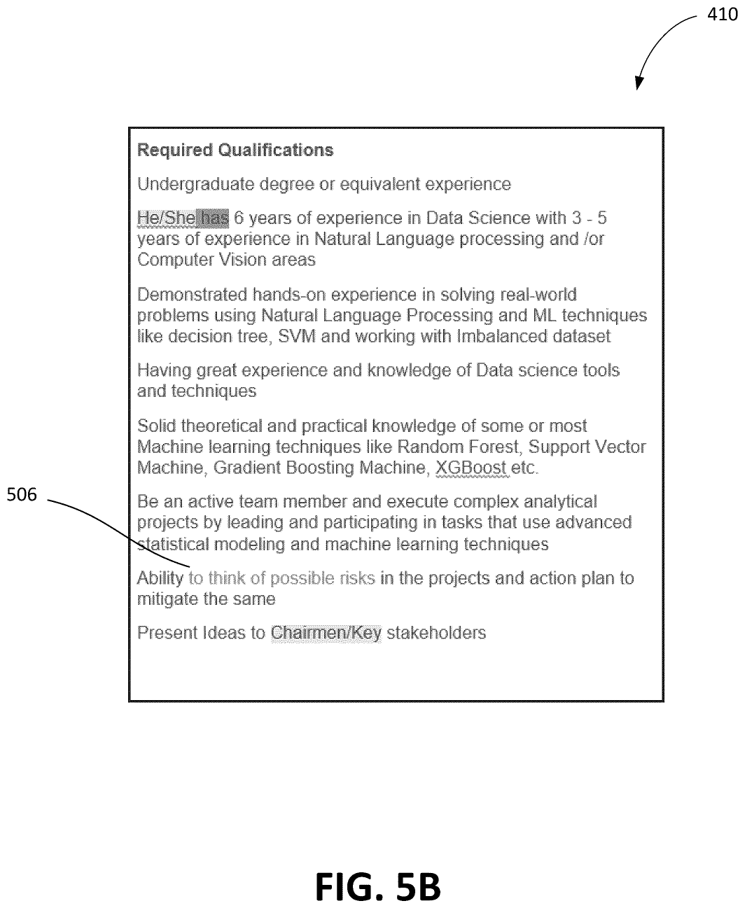

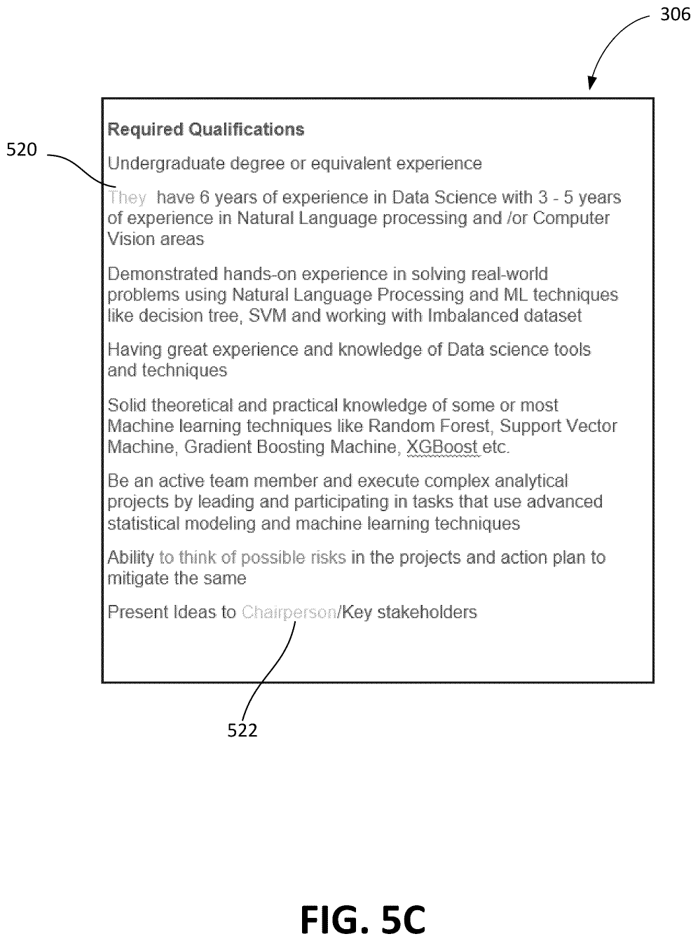

FIG. 5A depicts an operational example of an input document 502 in accordance with some embodiments discussed herein. The input document 502 may include an example of the document 302 described herein. As illustrated, the depicted input document 502 may be a job description document that includes text data 504. The text data 504 may include a portion 506 that includes grammatical errors. As further depicted, the text data 504 may include syntactic bias terms 508, 509 and candidate semantic bias terms 510-513. The input document 502 may be processed to generate a grammar corrected document.

FIG. 5B depicts an operational example of a grammar corrected document 410 in accordance with some embodiments discussed herein. As illustrated, the portion 506 in the input document 502 that included grammatical errors may be identified and corrected using one or more techniques configured to correct grammatical errors as described herein.

FIG. 5C depicts an operational example, of a syntactic debiased document 306 in accordance with some embodiments discussed herein. The syntactic debiased document 306 may comprise output of the first stage 312 of the contextually aware debiasing techniques discussed herein. As illustrated, syntactic bias terms 508, 509 present in the input document 502 may be identified and replaced with non-bias terms 520, 522. The syntactic debiased document 306 may be processed in the second stage of the contextually aware debiasing technique to generate output document that provides replacement token(s) for the semantic bias terms in the document.

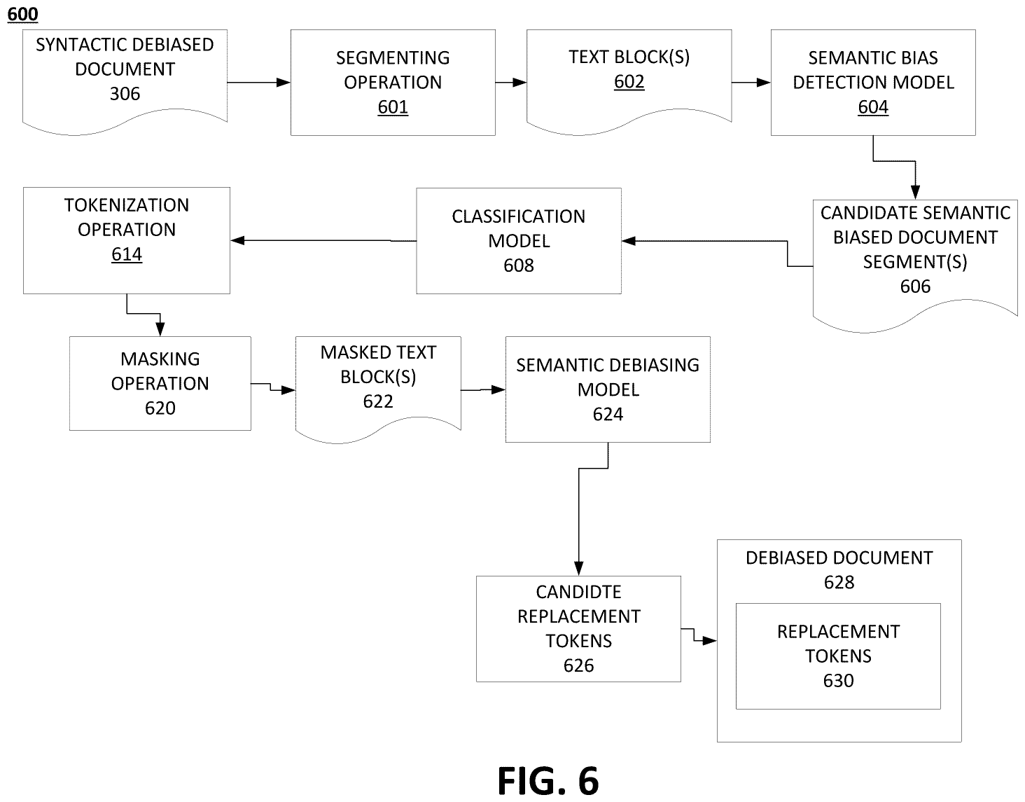

FIG. 6 is a dataflow diagram of the second stage of the contextually aware debiasing technique in accordance with some embodiments discussed herein. The dataflow diagram illustrates a plurality of data and/or computing entities that may be collectively (and/or in one or more combinations) leveraged to generate and provide replacement tokens for a semantic bias term.

In some embodiments, a syntactic debiased document 306 is segmented into one or more text blocks 602. In some embodiments, a text block is a data entity that describes a collection of one or more document segments. In some embodiments, a text block includes a sequence of one or more sentences from a syntactic debiased document 306. In some examples, the syntactic debiased document 306 may be segmented into one or more text blocks with each text block having substantially the same number of document segments. In some examples, the syntactic debiased document 306 may be segmented into one or more text blocks with at least a subset of the one or more text blocks having substantially the same number of document segments. In some examples, the syntactic debiased document 306 may be segmented into one or more text blocks with at least a subset of the one or more text blocks having different number of document segments.

In some embodiments, to segment the syntactic debiased document 306 into one or more text blocks 602, a segmenting operation 601 is first performed on the syntactic debiased document 306 to segment the syntactic debiased document 306 into one or more document segments. Subsets of the one or more document segments may then be aggregated or otherwise compiled to generate the one or more text blocks. One or more techniques may be utilized to segment the syntactic debiased document 306 into one or more document segments. In some embodiments, the contextually aware debiasing technique leverages a segmenting model, such as the segmenting model 414 to segment the syntactic debiased document 306 into one or more document segments.

In some embodiments, the one or more text blocks 602 are processed to generate one or more candidate semantic biased document segments 606. In some embodiments, a candidate semantic biased document segment is a data entity that describes a document segment that includes at least one candidate semantic bias term. In some embodiments, each of the one or more text blocks 602 is processed to determine if the one or more document segments of the respective text block includes at least one candidate semantic bias term. For example, the contextually aware debiasing technique includes iterating through each document segment of a text block to determine if a document segment includes at least one candidate semantic bias term. In some embodiments, each document segment that includes at least one candidate semantic bias term is designated a candidate semantic biased document segment. In some embodiments, the one or more text blocks 602 are processed separately. In some embodiments, subsets of the one or more text blocks 602 may be processed in parallel. In some embodiments, the contextually aware debiasing technique leverages a semantic bias detection model 604 to generate the one or more candidate semantic biased document segments 606.

In some embodiments, a semantic bias detection model 604 is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the semantic bias detection model 604 may be configured, trained, and/or the like to process a document segment to determine if the document segment includes at least one candidate semantic bias term (e.g., candidate semantic biased document segments). The semantic bias detection model 604 may include one or more of any type of machine learning model including one or more supervised, unsupervised, semi-supervised, reinforcement learning models, and/or the like. In some examples, the semantic bias detection model 604 may be previously trained using one or more supervised machine learning techniques. In some examples, the semantic bias detection model 604 includes a rules-based model configured to apply a set of one or more rules to identify candidate semantic bias terms present in a document segment. In some examples, the semantic bias detection model 604 may be configured, trained, and/or the like to identify candidate semantic bias terms from a document segment based on a semantic bias corpus. For example, the semantic bias detection model 604 may be configured, trained, and/or the like to iterate through a document segment to determine if a word token of the document segment is included in a semantic bias corpus. In some embodiments, a semantic bias corpus includes a collection of candidate semantic bias terms aggregated or otherwise compiled from one or more sources. In some examples, the semantic bias detection model 604 may include multiple models configured to perform one or more different stages of a bias identifying task. In some embodiments, the semantic bias detection model 604 may include one or more language models, such as BERT models, universal sentence encoder models, and/or the like.

In some embodiments, the one or more candidate semantic biased document segments 606 are processed to classify the one or more candidate semantic biased document segments 606 based on semantic bias criteria. For example, each of the one or more candidate semantic biased document segments 606 is processed to determine if a candidate semantic bias term from the candidate semantic biased document segment 606 is used in a context that renders the candidate semantic bias term a semantic bias term. In some embodiments, the contextually aware debiasing technique leverages a classification model 608 to classify candidate semantic biased document segments.

In some embodiments a classification model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. For instance, a classification model may include a language model that is configured, trained, and/or the like to process a document segment to generate a bias classification for the document segment. In some examples, a language model may include a machine learning model including one or more supervised, unsupervised, semi-supervised, reinforcement learning models, and/or the like. In some examples, the classification model may include multiple models configured to perform one or more different stages of a classification process.

In some examples, the classification model may include a binary classifier previously trained through one or more supervised training techniques. For instance, the classification model may include a natural language processor (NLP) model, such as a BERT model, universal sentence encoder models, and/or the like, configured, trained, and/or the like to generate a bias classification for a document segment. For example, the classification model may include a BERT model trained as a classifier to process a natural language sentence having one or more candidate semantic bias terms to generate a bias classification for the sentence based on semantic bias criteria. The classification model, for example, may be trained (e.g., via back-propagation of errors, etc.) using a labeled training dataset including a plurality of training document segments (e.g., sentences from historical and/or synthetic documents) with corresponding bias classifications. The classification model may be configured for a particular prediction domain by training the model using labeled training from the particular domain. By way of example, in a job description domain, the classification model may be trained to generate a bias classification for a document segment using training document segments from one or more historical and/or synthetic job descriptions.

In some examples, the bias classification may include a positive and/or negative bias classification that is based on semantic bias criteria. The semantic bias criteria may define one or more semantic contexts for a document segment and/or whether each of the one or more semantic contexts corresponds to a positive and/or negative bias classification. By way of example, the classification model may be previously trained to classify a document segment into one of the one or more semantic contexts and based on the semantic bias criteria, to generate a bias classification for the document segment.

In some examples, the semantic bias criteria may be based on a prediction domain. For example, the semantic bias criteria may define one or more semantic contexts that describe whether a document segment is associated with a non-biased context or a biased context depending on the prediction domain. By way of example, in a job description domain, a first semantic context may include “desired quality” context in which a candidate semantic bias term may be used in a biased manner. In such a case, a positive bias classification may be output for a document segment classified as a “desired quality” context. In addition, or alternatively, in the job description domain, a second semantic context may include “nature of job” context in which a candidate semantic bias term may be used in an unbiased manner. In such a case, a negative bias classification may be output for a document segment classified as a “nature of job” context. The classification model may be trained to classify a document segment as a positive bias classification where the document segment includes at least one semantic bias term used in the context of desired quality. For example, in a job description domain, the classification model may be trained to classify a candidate semantic biased document segment as a negative bias classification where none of the candidate semantic bias terms from the document segment is used in the context of desired quality. In some examples, the classification model may be previously trained using one or more supervised machine learning techniques and a training dataset associated with a particular prediction domain. By way of example, in a job description domain, the training dataset may include a plurality of labeled job descriptions. For example, each sentence from a job description having at least one candidate semantic bias term may be labeled as associated with “desired quality” context or “nature of job” context. In such example, a “desired quality” context may be indicative of semantic bias, while “nature of job” context may be indicative of non-bias. In some embodiments, a document segment having a positive bias classification may be flagged for further processing.

In some embodiments, a tokenization operation 614 is performed on the document segments of the one or more text blocks 602 to segment the document segments into one or more word tokens. In some embodiments, the contextually aware debiasing technique leverages a tokenizer model, such as the tokenizer model 426 (described above) to segment a document segment into one or more word tokens. In some examples, the tokenizer model may include a BERT tokenizer.

In some embodiments, a masking operation 620 is performed on the one or more text blocks 602 to generate one or more masked text blocks 622. A masked text block may include one or more masked tokens, each corresponding to a candidate semantic bias term from a document segment having a positive bias classification. For example, for each text block 602, candidate semantic bias terms in each document segment that have a positive bias classification (e.g., candidate semantic biased document segment) may be masked. In some embodiments, the one or more masked text blocks are generated based on the semantic bias corpus. For example, the contextually aware debiasing technique may include iterating though a document segment having a positive bias classification to identify and mask word tokens within the document segment that are found in the semantic bias corpus. For example, the masking operation 620 includes determining whether a word token is included in the semantic bias corpus and masking the word token if determined to be included. In some embodiments, the masking operation 620 includes identifying the position of a masked token in the corresponding document segment.

In some embodiments, candidate replacement tokens are generated for the masked tokens in a masked text block. For example, one or more candidate replacement tokens may be generated for each masked token. In some embodiments, the contextually aware debiasing technique leverages a semantic debiasing model 624 and a fill mask configuration to generate the one or more candidate replacement tokens 626.

In some embodiments, a semantic debiasing model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. In some examples, the semantic debiasing model 624 may be configured, trained, and/or the like to process masked text data (e.g., masked text block) to generate one or more candidate replacement tokens for masked token(s). The semantic debiasing model 624 may include one or more of any type of machine learning model including one or more supervised, unsupervised, semi-supervised, reinforcement learning models, and/or the like. In some examples, the semantic debiasing model 624 may be previously trained using one or more supervised machine learning techniques. In some examples, the semantic debiasing model 624 may include multiple models configured to perform one or more different stages of a token recommendation task. In some embodiments, the semantic debiasing model 624 may include one or more language models, such as BERT models, universal sentence encoder models, and/or the like. In one example, the semantic debiasing model 624 includes a BERT-based model pre-trained based on text data associated with the prediction domain to, for example, align the BERT-based model with the verbiage and/or nuances of text data associated with the prediction domain. For example, in a job description domain, the semantic debiasing model may include a BERT-based model pre-trained based on a plurality of job description documents to align the BERT-based model with the verbiage and/or nuances of text data often used in job descriptions.

In some embodiments, the semantic debiasing model 624 is configured, trained, and/or the like to predict the one or more candidate replacement tokens for a masked token based on context information of the text block and/or document segment that includes the masked token. In this manner, the semantic debiasing model 624 captures and preserves the context of the text block and/or document segment.

In some embodiments, the one or more candidate replacement tokens generated for a masked token are ordered in a descending order indicative (e.g., including an identifier) of the relevancy of the candidate replacement tokens. For example, candidate replacement tokens determined (e.g., by the semantic debiasing model 624) to be the most contextually relevant to replace a masked token may appear first in a list of candidate replacement tokens. In some embodiments, the semantic debiasing model 624 may be configured to assign a relevancy score to each candidate replacement token.

In some embodiments, one or more replacement tokens 630 are generated for a masked token based on the one or more candidate replacement tokens for the masked token. For example, one or more replacement tokens 630 are selected from the one or more candidate replacement tokens 626 based on the semantic bias corpus. For instance, the contextually aware debiasing technique may include comparing the one or more candidate replacement tokens for a masked token with the semantic bias corpus to determine and select candidate replacement token(s) that are not found in the semantic bias corpus.

In some embodiments, the semantic debiasing model 624 may be configured to generate the replacement token(s) 630. For example, the semantic debiasing model 624 may be configured, trained, and/or the like to generate the one or more replacement tokens 630 based on a semantic bias corpus. By way of example, one or more models associated with a first stage of a semantic debiasing model may be configured to generate candidate replacement token(s) for a masked token, while one or more models associated with a second stage of the semantic debiasing model may be configured to select one or more of the candidate replacement tokens as the replacement token(s) for the masked token based on the semantic bias corpus. By way of another example, separate models may be used to generate candidate replacement tokens and replacement tokens recommended to an end user.

In some embodiments, the contextually aware debiasing technique is configured to output a debiased document 628 at the second stage 314 based on performing one or more of the operations described above. For example, a debiased document 628 corresponding to the document 302 may be generated, where, at least, syntactic and semantic bias terms present in the document 302 have been identified, replaced (or otherwise provided) in the debiased document 628. In some embodiments, the debiased document 628 is presented on a user interface.

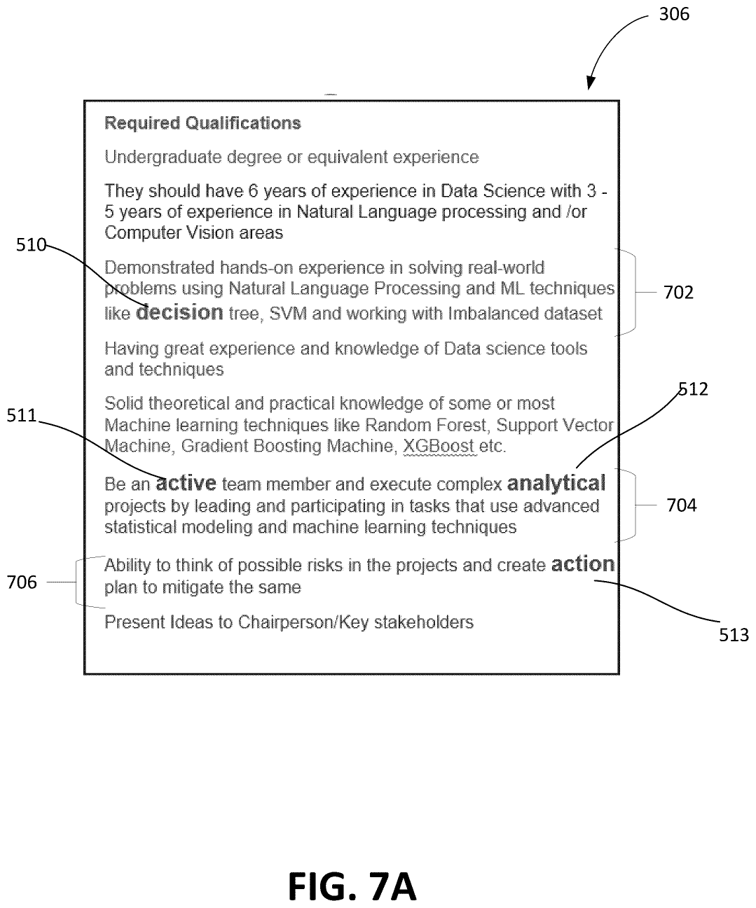

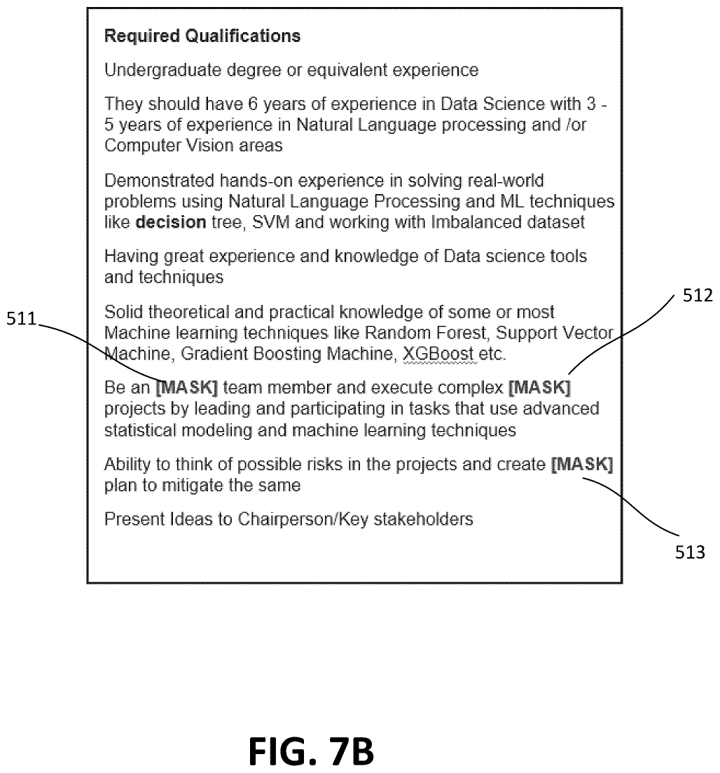

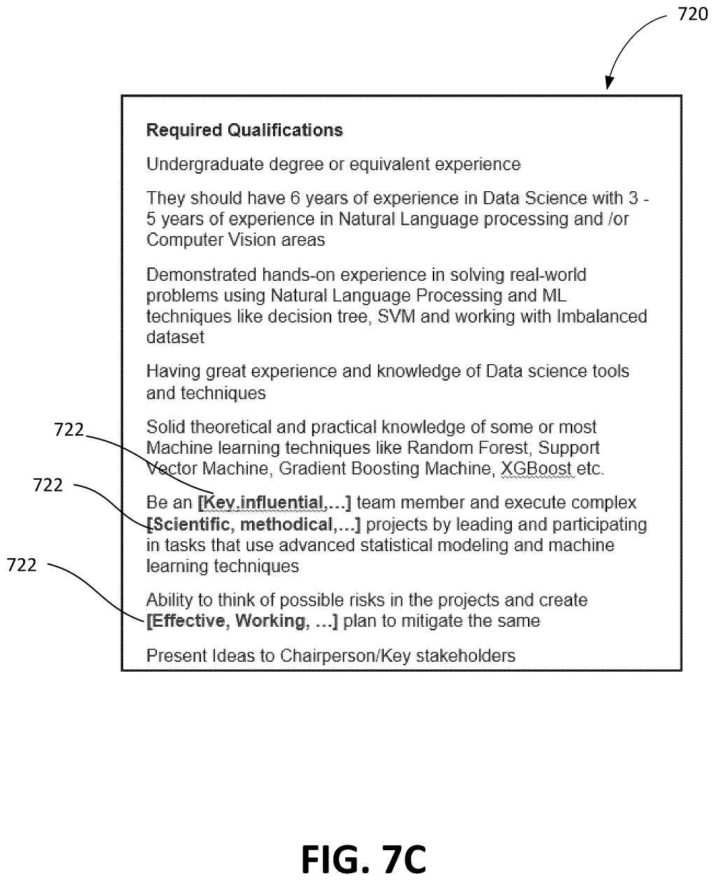

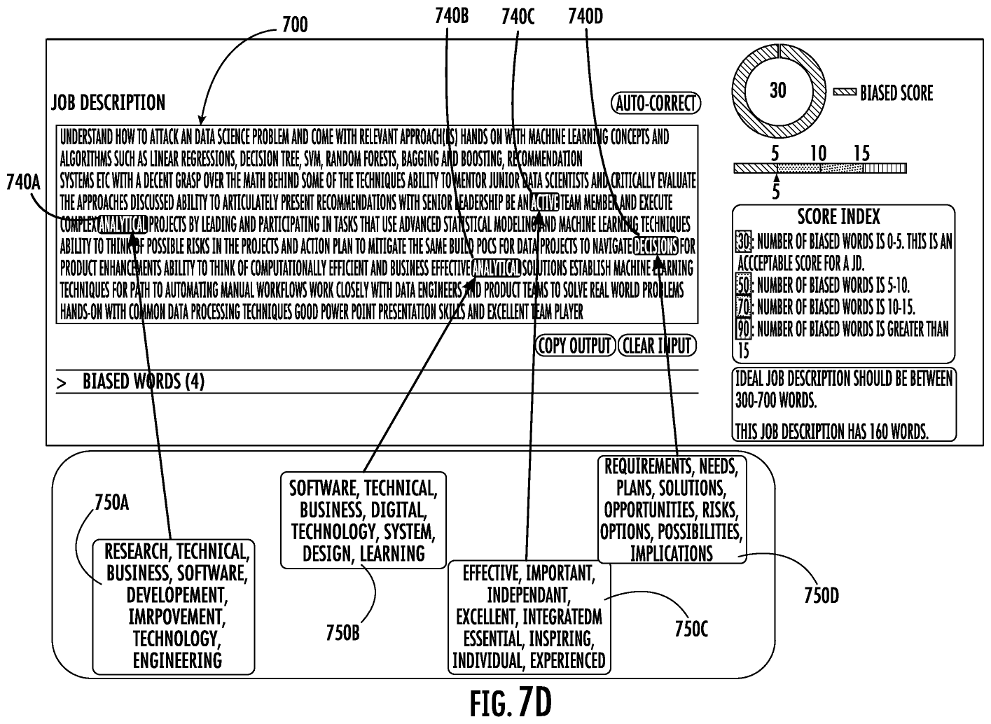

FIG. 7A depicts an operational example of a syntactic debiased document 306 showing bias classifications in accordance with some embodiments discussed herein. As illustrated, the syntactic debiased document 306 (e.g., output of the first stage 312 may be processed to classify sentence 702, 704, 706 that each include at least one candidate semantic bias term. For example, as depicted, sentence 702 includes candidate semantic bias term 510, sentence 704 includes candidate semantic bias terms 511, 512, and sentence 706 includes candidate semantic bias term 513. Sentence 702 may be classified as a negative biased document segment using a classification model as described herein. The negative bias classification for the sentence 702 may reflect or otherwise be based on a determination that the candidate semantic bias term 513 is used in the sentence 702 in a non-bias context (e.g., nature of job context). Sentence 704 may be classified as a positive biased document segment using the classification model. The positive bias classification for the sentence 704 may reflect or otherwise be based on a determination that the candidate semantic bias term 511 and/or 512 is used in the sentence 704 in a bias context (e.g., desired quality context). Sentence 706 may be classified as a positive biased document segment using the classification model. The positive bias classification for sentence 706 may reflect or otherwise be based on a determination that the candidate semantic bias term 513 is used in the sentence 706 in a bias context (e.g., desired quality).

FIG. 7B depicts an operational example of masked tokens in accordance with some embodiments discussed herein. As depicted, each of candidate semantic bias terms 511, 512 in the sentence 704 classified as a positive bias sentence may be masked. As further depicted, candidate semantic bias term 513 in the sentence 706 classified as a negative bias sentence may be masked.

FIG. 7C depicts an operational example of output document 720 of a contextually aware debiasing technique in accordance with some embodiments discussed herein. As illustrated, the output document 720 may represent a version of the input document 502 that has been processed to debias the input document 502. As illustrated, one or more replacement tokens 722 (e.g., non-bias term(s)) may be provided or otherwise recommended for a masked token (e.g., the candidate semantic bias terms 511, 512, 513) using a semantic debiasing model and based on the context of surrounding words.

FIG. 7D depicts an example user interface displaying a debiased document in accordance with some embodiments discussed herein. As depicted in FIG. 7D, the user interface may display a debiased job description document 700. As depicted in FIG. 7D, syntactic bias terms identified in the job description document may be automatically replaced with corresponding non-bias terms. As further depicted in FIG. 7D, the user interface may include for each semantic bias term 740A-D identified in the job description document, sets of one or more recommended non-bias terms 750A-D, respectively. A non-bias term from the set of one or more recommended non-bias term for a semantic bias term may be selected (e.g., by a user) to replace the semantic bias term.

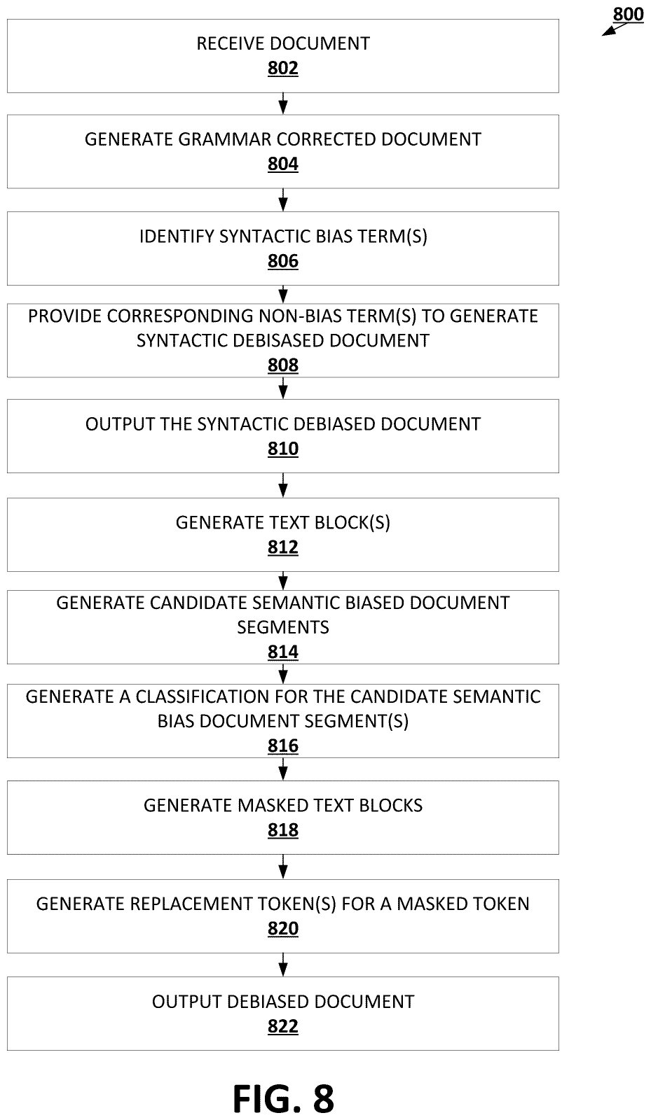

FIG. 8 is a flow chart showing an example of a process 800 for debiasing a document in accordance with some embodiments discussed herein. The flowchart depicts a multi-stage contextually aware debiasing technique that overcomes various limitations associated with traditional debiasing techniques. The multi-stage contextually aware debiasing technique may be implemented by one or more computing devices, entities, and/or systems described herein. For example, via the various steps/operations of the process 800, the computing system 100 may leverage the multi-stage contextually aware debiasing technique to interpret text and automatically identify both syntactic and semantic bias terms within a document and provide non-bias replacement terms to overcome the various limitations of existing debiasing techniques that are unable to do so.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In this regard, different components of an example device or system that implements the process 800 may perform functions at substantially the same time or in a specific sequence.

In some embodiments, the process 800 includes, at step/operation 802, receiving a document (e.g., input document). The document may include one or more bias terms. For example, the document may include one or more syntactic bias terms and/or one or more semantic bias terms.

In some embodiments, the process 800 includes, at step/operation 804, generating a grammar corrected document. For example, the computing system 100 may apply one or more techniques to correct grammatical errors (if any) associated with the document. In some examples, the computing system 100 may generate the grammar corrected document using a grammar correction model configured, trained, and/or the like to process the document to identify and/or correct grammatical errors (if any) present in the document. For example, the computing system 100, using the grammar correction model, may iterate through each document segment from the document to identify and/or correct grammatical errors (if any) associated with each document segment. The grammar correction model may include one or more of any type of machine learning model including one or more supervised, unsupervised, semi-supervised, reinforcement learning models, and/or the like. By way of example, the computing system 100 may utilize a python language tool wrapper.

In some embodiments, computing system 100 preprocesses the document prior to identifying and/or grammatical errors present in the document. For example, the computing system 100 may perform a text preprocessing operation on the document to generate a preprocessed document. The text preprocessing operation may include text cleaning to remove stop words, special characters (e.g., bullet points, punctuations, emoticons, Unicode characters, and/or the like), and/or the like from text data present in the document. The computing system 100 may utilize any of variety of preprocessing techniques. By way of example, the computing system 100 may utilize regular expressions-based technique.

In some embodiments, the computing system 100 generates one or more document segments prior to identifying and/or grammatical errors present in the document. For example, to generate the grammar corrected document, the computing system 100 may first segment the preprocessed document into document segments. In some examples, the computing system 100 may utilize a segmenting model to segment the document into document segments. The computing system 100 may then, utilizing the grammar correction model, process the document segments to identify and/or correct grammatical errors (if any) present in the document segments.

In some embodiments, the process 800 includes, at step/operation 806, identifying syntactic bias term(s) in the grammar corrected document. In some embodiments, to identify the syntactic bias terms, the computing system 100 tokenizes one or more document segments. For example, the computing system 100, using a tokenizer model, may segment each document segment into one or more word tokens. In some examples, the tokenizer model comprises a BERT tokenizer. In some embodiments, the computing system 100 determines the part of speech associated with a word token using one or more part of speech tagging techniques. By way of example, the computing system 100 may determine, for each document segment, the part of speech associated with each word in the document segment. In some embodiments, the computing system 100 leverages the part of speech tags to identify syntactic bias terms in a document. For example, the computing system 100 may identify syntactic bias terms present in the document based on the part of speech tags and/or a syntactic bias corpus. The syntactic bias corpus may include a collection of syntactic bias terms including, for example, binary pronouns, gender-specific nouns, and/or other syntactic bias terms. The computing system 100 may iterate through a document segment to determine if a word token in the document segment is included in the syntactic bias corpus. For example, the computing system 100 may utilize the syntactic bias corpus as a look up table to determine if a word token is included in the syntactic bias corpus. In some embodiments, the computing system 100 may utilize a syntactic bias detection model to identify binary pronouns, gendered-specific nouns, and/or other syntactic bias terms. For example, the syntactic bias detection model may be configured, trained, and/or the like to process document segments to identify and/or replace syntactic bias terms present in the document segments based on syntactic debiasing criteria. In some examples, the syntactic bias detection model may include a machine learning model. Alternatively, or additionally, in some examples, the syntactic bias detection model may include a rule-based model.

In some embodiments, the process 800 includes, at step/operation 808, providing corresponding non-bias term(s) for the identified syntactic bias term(s) to generate a syntactic debiased document. In some embodiments, a syntactic debiased document is previously generated using the syntactic debiasing criteria by replacing the syntactic bias terms with the corresponding non-bias terms within the grammar corrected document. For example, the computing system 100 may replace syntactic bias terms identified at step/operation 806 with corresponding non-bias terms. By way of example, the computing system may replace “he” with “they,” replace “hers” with “theirs,” and/or the like. In some embodiments, the computing system 100 may utilize a syntactic bias detection model to determine the corresponding non-bias term for an identified syntactic bias term, and replace the syntactic bias term with the corresponding non-bias term. In some examples, the model may be configured to apply a set of one or more rules (e.g., syntactic debiasing criteria) to a document segment to replace a syntactic bias term. In some examples, the part of speech tags and/or dependency parse tag for a word may be utilized to disambiguate between one-many transformations.

In some embodiments, the process 800 includes, at step/operation 810, outputting the syntactic debiased document. The syntactic debiased document may comprise or otherwise represent a version of the input document that has been processed to correct grammatical error(s) and replace syntactic bias terms previously within the input document with corresponding non-bias terms.

In some embodiments, the computing system performs a grammar verification operations prior to outputting the syntactic debiased document. For example, the computing system 100 may perform a grammar verification operation that includes identifying subject-verb agreement error(s) (if any) in a document segment and/or correcting identified subject-verb agreement error(s). By way of example, the computing system may leverage the part of speech tags and/or dependency parse tag for the word tokens in the document segment to identify subject-verb agreement error(s).

In some embodiments, the process 800 includes, at step/operation 812, generating one or more text blocks. In some embodiments, the computing system may segment the syntactic debiased document into one or more text blocks (e.g., a group of one or more document segments, such as ten sentences). For example, to generate the one or more text blocks, the computing system 100 may segment the syntactic debiased document into one or more document segments, and group the document segments into one or more groups of N (e.g., N=5, 10, and/or the like) sequence of document segments. By way of example, the computing system 100 may segment the syntactic debiased document into one or more text blocks of equal sizes (e.g., substantially the same number of document segments).

In some embodiments, the process 800 includes, at step/operation 814, generating one or more candidate semantic biased document segments. In some embodiments, a candidate semantic biased document segment is a document segment that includes ate least one candidate semantic bias term. For example, the one or more candidate semantic biased document segments may include one or more document segments that each include a sequence of terms from a syntactic debiased document and at least one candidate semantic bias term. In some embodiments, for each text block, the computing system 100 processes each document segment (e.g., a sentence of the ten sentences, etc.) in the text block to determine if the document segment includes at least one candidate semantic bias term.

In some embodiments, the computing system 100 identifies one or more candidate semantic bias terms from a document segment of the one or more document segments based on a semantic bias corpus. The semantic bias corpus, for example, may include a list of predefined candidate semantic bias terms. In some embodiments, the computing system 100 compares a term (e.g., token) in a document segment to the semantic bias corpus to determine if the term is included in the semantic bias corpus.

In some examples, the computing system 100 utilizes a semantic bias detection model to generate the one or more candidate semantic biased document segments. The semantic bias detection model may be configured, trained, and/or the like to process a document segment to determine if the document segment includes at least one candidate semantic bias term. For example, the semantic bias detection model may be configured, trained, and/or the like to iterate through a document segment to determine if a word token in the document segment is included in the semantic bias corpus. In some examples, the syntactic bias detection model may include one or more language models, such as BERT models, universal sentence encoder models, and/or the like.

In some embodiments, the process 800 includes at step/operation 816, generating a classification for the one or more candidate semantic biased document segments based on semantic bias criteria. For example, in response to the identification of the one or more candidate semantic bias terms, the computing system 100, may generate, using a classification model, a bias classification for the document segment. For instance, the computing system 100 may process a text block that includes at least one candidate semantic biased document segment to classify the at least one candidate semantic biased document segment based on context information derived from the at least one candidate semantic biased document segment and/or text block that includes the at least one candidate semantic biased document segment. For example, for a text block that includes at least one candidate semantic biased document segment, the computing system 100, utilizing the classification model, processes the at least one candidate semantic biased document segment to determine if a candidate semantic bias term in the at least one candidate semantic biased document segment is used in a bias context. The classification model, for example, may include a machine learning model previously trained on a domain-specific text corpus based on semantic bias criteria that is based on a context of use of the one or more candidate semantic bias terms in the document segment. In some examples, the semantic bias criteria may define one or more semantic contexts and/or one or more bias classifications corresponding to each of the one or more semantic contexts.

As described herein, in some embodiments, a classification model is leveraged to generate a classification for the one or more candidate semantic biased document segments. In some examples, the classification model includes a BERT model trained as a classifier to process a document segment having one or more candidate semantic bias terms in order to generate a bias classification for the document segment based on the context of use of a candidate semantic bias term with respect to the document segment. For example, the classification model may be trained to compare a candidate semantic bias term from a candidate semantic biased document segment with the document segment to generate a bias classification for the candidate semantic bias term and/or the candidate semantic biased document segment. In some examples, the classification model may be configured to generate a positive bias classification or a negative bias classification for a candidate semantic biased document segment. In some examples, a positive bias classification may correspond to semantic bias classification, while a negative bias classification may correspond to a non-bias classification.

By way of example, in a job description domain, the classification model may be configured, trained, and/or the like to generate a bias classification for a document segment having one or more semantic bias terms based on whether a candidate semantic bias term is used in a “desired quality” context or a “nature of job” context with respect to that particular document segment. For example, in a job description domain, the classification model may be trained to classify a document segment as a positive biased document segment (e.g., positive bias classification) where the document segment includes at least one candidate semantic bias term that is used in the context of desired quality. For example, in a job description domain, the classification model may be trained to classify a candidate semantic biased document segment as a negative biased document segment (e.g., negative bias classification) where none of the candidate semantic bias terms from the candidate semantic biased document segment is used in the context of desired quality (e.g., used in the context of nature of job instead, for example). Continuing with the job description domain example, the classification model may be trained to classify a candidate semantic bias term as a positive bias classification where the candidate semantic bias term is used in the context of desired quality.

In some examples, the classification model may be previously trained using one or more supervised machine learning techniques and a training dataset associated with a particular prediction domain. By way of example, in a job description domain, the training dataset may include a plurality of labeled job descriptions. For example, each document segment from a job description having at least one semantic bias term may be labeled as associated with “desired quality” context or “nature of job” context. In such example, a “desired quality” context may be indicative of semantic bias, while “nature of job” context may be indicative of non-bias.

In some embodiments, the process includes, at step/operation 818, generating one or more masked text blocks. A masked text block may include one or more candidate semantic biased document segments having a positive bias classification. For example, a masked text block may include one or more candidate semantic biased document segments that each include one or more masked tokens corresponding to one or more candidate semantic bias terms. For example, the computing system 100 may generate for a candidate semantic biased document segment having a positive bias classification, one or more masked tokens corresponding to the one or more candidate semantic bias terms in the candidate biased document segment. In some examples, the computing system 100 may iterate though each text block to identify and mask word token(s) in a candidate semantic biased document segment having a positive bias classification based on the semantic bias corpus.

In some embodiments, the process includes, at step/operation 820, generating one or more replacement tokens for a masked token. For example, in response to a positive bias classification (e.g., for a candidate semantic document segment), the computing system 100 may provide, using a semantic debiasing model, one or more replacement tokens for the one or more candidate semantic bias terms. For instance, the computing system 100 may generate one or more replacement tokens for a masked token, utilizing a semantic debiasing model and based on the context of surrounding words and/or the semantic bias corpus. The computing system 100 may generate, using the semantic debiasing model and based on context information of the document segment, the one or more replacement tokens for the one or more candidate semantic bias terms. In some examples, the computing system 100 may identify a subset of document segments (e.g., a text block) and generate, using a semantic debiasing model, the one or more replacement tokens for the one or more candidate semantic bias terms based on the subset of document segments.

In some examples, the semantic debiasing model may include a BERT-based model pre-trained based on text data associated with the prediction domain. For example, in a job description domain, the semantic debiasing model may include a BERT-based model pre-trained based on a plurality of job description documents to align the BERT-based model with the verbiage and/or nuances of text data often used in job descriptions.

In some embodiments, the one or more replacement tokens may be selected from one or more candidate replacement tokens based on comparing the one or more candidate replacement tokens with the semantic bias corpus. For example, in some embodiments, the semantic debiasing model may be configured to generate candidate replacement tokens and then compare the candidate replacement tokens with the semantic bias corpus. The semantic debiasing model, for example may be configured to select candidate replacement tokens that are not in the semantic bias corpus as the replacement tokens. In some embodiments, a fill-mask configuration is leveraged. For example, the computing system 100, utilizing the semantic debiasing model and a fill-mask technique, may generate the one or more candidate replacement tokens.

In some embodiments, the process 800 includes, at step/operation 822, outputting a debiased document. The debiased document may comprise or otherwise represent a version of the input document that has been at least syntactically debiased by replacing syntactic bias terms with non-bias terms identified in the input document and/or semantically debiased by providing non-biased replacement tokens (e.g., replacement terms) for semantic bias terms identified in the input document. In some embodiments, the computing system 100 may provide or otherwise present the one or more replacement tokens, for example, to an end user (e.g., via a user interface). For example, the computing system 100 may present the one or more replacement tokens for a masked token in the position of the masked token in the document, where a user may select from the one or more replacement tokens. Alternatively or additionally, in some embodiments, the computing system 100 may select a replacement token from the one or more replacement tokens and automatically replace the masked token with the selected replacement token.

As indicated, various embodiments of the present disclosure make important technical contributions to machine learning text interpretation and debiasing techniques. In particular, systems and methods are disclosed herein that implement a multi-stage contextually aware debiasing technique configured to identify and replace both syntactic and semantic bias terms present in a document. As described, the multi-stage contextually aware debiasing technique provides technical improvements over traditional language processing techniques by leveraging a machine learning pipeline configured to classify the context in which a term is used to inform bias predictions. This, in turn, improves upon traditional language processing techniques, such as rule-based bias detection, by generating contextually aware bias predictions that may be leveraged to generate term recommendations tailored to the context in which a bias term may be replaced. By doing so, some techniques of the present disclosure improve the accuracy, efficiency, reliability, and relevance of conventional debiasing engines.

As described herein, the contextually aware debiasing techniques improve traditional debiasing techniques by intelligently processing text data to generate optimized debiased text data. The contextually aware debiasing techniques may be leveraged to identify, replace, and/or recommend both syntactic and semantic bias term(s) present in a document. In some embodiments, one or more data processing operations is leveraged to generate a syntactic debiased document. Some embodiments may segment the syntactic debiased document into one or more document segments that may be individually and/or collectively analyzed to identify documents segments that include semantic bias term(s) based on the context of the document segment. Some embodiments of the present disclosure may generate a bias classification for a candidate semantic bias term based on contextual information derived from the segment of the document in which the candidate semantic bias term is identified. The bias classification may be leveraged to determine if a candidate semantic bias term qualifies as a semantic bias term and/or to classify the document segment. In this manner, using some of the techniques of the present disclosure, a document may be accurately debiased based on the context of the document, which improves the accuracy, reliability, and relevance of debiasing operations performed by traditional computer-based techniques.

In some embodiments, one or more data processing operations may be applied to identify and provide contextually aware non-bias term(s) for semantic bias term(s). Some embodiments may group the document segments into one or more text blocks (e.g., each text block including one or more document segments) that may be individually and/or collectively analyzed to determine replacement terms for semantic bias term(s) in a manner that captures and preserves the context of the document segment and/or text block that includes the semantic bias term(s). In this way, using some of the techniques of the present disclosure, a document may be accurately debiased based on the context of the document, which improves the accuracy, reliability, and relevance of debiasing operations performed by traditional computer-based techniques. Ultimately, this reduces the computing expense, while improving the performance (e.g., accuracy, completeness, speed, efficiency, computing power) of existing debiasing techniques.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising generating, by one or more processors, one or more document segments that each comprise a sequence of terms from a syntactic debiased document; identifying, by the one or more processors, one or more candidate semantic bias terms from a document segment of the one or more document segments based on a semantic bias corpus; in response to the identification of the one or more candidate semantic bias terms, generating, by the one or more processors and using a classification model, a bias classification for the document segment; and in response to a positive bias classification, providing, by the one or more processors and using a semantic debiasing model, one or more replacement tokens for the one or more candidate semantic bias terms.

Example 2. The computer-implemented method of example 1, wherein the syntactic debiased document is previously generated using syntactic debiasing criteria by identifying a syntactic bias term in a grammar corrected document; generating a corresponding non-bias term for the syntactic bias term based on the syntactic debiasing criteria; and generating the syntactic debiased document by replacing the syntactic bias term with the corresponding non-bias term within the grammar corrected document.

Example 3. The computer-implemented method of any of the preceding examples, wherein the classification model comprises a machine learning model previously trained on a domain-specific text corpus based on semantic bias criteria that is based on a context of use of the one or more candidate semantic bias terms in the document segment.

Example 4. The computer-implemented method of example 3, wherein the semantic bias criteria defines one or more semantic contexts and one or more bias classifications corresponding to each of the one or more semantic contexts.

Example 5. The computer-implemented method of examples 3 or 4, wherein providing, using the semantic debiasing model, the one or more replacement tokens for the one or more candidate semantic bias terms comprises identifying a subset of document segments; and generating, using the semantic debiasing model, the one or more replacement tokens for the one or more candidate semantic bias terms based on the subset of document segments.

Example 6. The computer-implemented method of any of the preceding examples, wherein the one or more replacement tokens are selected from one or more candidate replacement tokens based on comparing the one or more candidate replacement tokens with the semantic bias corpus.

Example 7. The computer-implemented method of example 6, wherein the one or more candidate replacement tokens are generated by generating one or more masked tokens corresponding to the one or more candidate semantic bias terms; and generating, using the semantic debiasing model and based on context information of the document segment, the one or more replacement tokens for the one or more candidate semantic bias terms.

Example 8. A computing system comprising memory and one or more processors communicatively coupled to the memory, the one or more processors configured to generate one or more document segments that each comprise a sequence of terms from a syntactic debiased document; identify one or more candidate semantic bias terms from a document segment of the one or more document segments based on a semantic bias corpus; in response to the identification of the one or more candidate semantic bias terms, generate, using a classification model, a bias classification for the document segment; and in response to a positive bias classification, provide, using a semantic debiasing model, one or more replacement tokens for the one or more candidate semantic bias terms.

Example 9. The computing system of example 8, wherein the syntactic debiased document is previously generated using syntactic debiasing criteria by identifying a syntactic bias term in a grammar corrected document; generating a corresponding non-bias term for the syntactic bias term based on the syntactic debiasing criteria; and generating the syntactic debiased document by replacing the syntactic bias term with the corresponding non-bias term within the grammar corrected document.

Example 10. The computing system of examples 8 or 9, wherein the classification model comprises a machine learning model previously trained on a domain-specific text corpus based on semantic bias criteria that is based on a context of use of the one or more candidate semantic bias terms in the document segment.

Example 11. The computing system of example 10, wherein the semantic bias criteria defines one or more semantic contexts and one or more bias classifications corresponding to each of the one or more semantic contexts.

Example 12. The computing system of examples 10 or 11, wherein providing, using the semantic debiasing model, the one or more replacement tokens for the one or more candidate semantic bias terms comprises: identifying a subset of document segments; and generating, using the semantic debiasing model, the one or more replacement tokens for the one or more candidate semantic bias terms based on the subset of document segments.

Example 13. The computing system of any of examples 8-12, wherein the one or more replacement tokens are selected from one or more candidate replacement tokens based on comparing the one or more candidate replacement tokens with the semantic bias corpus.

Example 14. The computer-implemented method of example 13, wherein the one or more candidate replacement tokens are generated by generating one or more masked tokens corresponding to the one or more candidate semantic bias terms; and generating, using the semantic debiasing model and based on context information of the document segment, the one or more replacement tokens for the one or more candidate semantic bias terms.

Example 15. One or more non-transitory computer-readable storage media including instructions that, when executed by one or more processors, cause the one or more processors to generate one or more document segments that each comprise a sequence of terms from a syntactic debiased document; identify one or more candidate semantic bias terms from a document segment of the one or more document segments based on a semantic bias corpus; in response to the identification of the one or more candidate semantic bias terms, generate, using a classification model, a bias classification for the document segment; and in response to a positive bias classification, provide, using a semantic debiasing model, one or more replacement tokens for the one or more candidate semantic bias terms.

Example 16. The one or more non-transitory computer-readable storage media of example 15, wherein the syntactic debiased document is previously generated using syntactic debiasing criteria by identifying a syntactic bias term in a grammar corrected document; generating a corresponding non-bias term for the syntactic bias term based on the syntactic debiasing criteria; and generating the syntactic debiased document by replacing the syntactic bias term with the corresponding non-bias term within the grammar corrected document.

Example 17. The one or more non-transitory computer-readable storage media of examples 15 or 16, wherein the classification model comprises a machine learning model previously trained on a domain-specific text corpus based on semantic bias criteria that is based on a context of use of the one or more candidate semantic bias terms in the document segment.

Example 18. The one or more non-transitory computer-readable storage media of example 17, wherein the semantic bias criteria defines one or more semantic contexts and one or more bias classifications corresponding to each of the one or more semantic contexts.

Example 19. The one or more non-transitory computer-readable storage media of examples 17 or 18, wherein providing, using the semantic debiasing model, the one or more replacement tokens for the one or more candidate semantic bias terms comprises identifying a subset of document segments; and generating, using the semantic debiasing model, the one or more replacement tokens for the one or more candidate semantic bias terms based on the subset of document segments.

Example 20. The one or more non-transitory computer-readable storage media of examples 15-19, wherein the one or more replacement tokens are selected from one or more candidate replacement tokens based on comparing the one or more candidate replacement tokens with the semantic bias corpus.

1. A computer-implemented method comprising:
generating, by one or more processors, one or more document segments that each comprise a sequence of terms from a syntactic debiased document;
identifying, by the one or more processors, one or more candidate semantic bias terms from a document segment of the one or more document segments based on a semantic bias corpus;
in response to the identification of the one or more candidate semantic bias terms, generating, by the one or more processors and using a classification model, a bias classification for the document segment; and
in response to a positive bias classification, providing, by the one or more processors and using a semantic debiasing model, one or more replacement tokens for the one or more candidate semantic bias terms.

2. The computer-implemented method of claim 1, wherein the syntactic debiased document is previously generated using syntactic debiasing criteria by:
identifying a syntactic bias term in a grammar corrected document;
generating a corresponding non-bias term for the syntactic bias term based on the syntactic debiasing criteria; and
generating the syntactic debiased document by replacing the syntactic bias term with the corresponding non-bias term within the grammar corrected document.

3. The computer-implemented method of claim 1, wherein the classification model comprises a machine learning model previously trained on a domain-specific text corpus based on semantic bias criteria that is based on a context of use of the one or more candidate semantic bias terms in the document segment.

4. The computer-implemented method of claim 3, wherein the semantic bias criteria defines one or more semantic contexts and one or more bias classifications corresponding to each of the one or more semantic contexts.

5. The computer-implemented method of claim 4, wherein providing, using the semantic debiasing model, the one or more replacement tokens for the one or more candidate semantic bias terms comprises:
identifying a subset of document segments; and
generating, using the semantic debiasing model, the one or more replacement tokens for the one or more candidate semantic bias terms based on the subset of document segments.

6. The computer-implemented method of claim 1, wherein the one or more replacement tokens are selected from one or more candidate replacement tokens based on comparing the one or more candidate replacement tokens with the semantic bias corpus.

7. The computer-implemented method of claim 6, wherein the one or more candidate replacement tokens are generated by:
generating one or more masked tokens corresponding to the one or more candidate semantic bias terms; and
generating, using the semantic debiasing model and based on context information of the document segment, the one or more replacement tokens for the one or more candidate semantic bias terms.

8. A computing system comprising memory and one or more processors communicatively coupled to the memory, the one or more processors configured to:
generate one or more document segments that each comprise a sequence of terms from a syntactic debiased document;
identify one or more candidate semantic bias terms from a document segment of the one or more document segments based on a semantic bias corpus;
in response to the identification of the one or more candidate semantic bias terms, generate, using a classification model, a bias classification for the document segment; and
in response to a positive bias classification, provide, using a semantic debiasing model, one or more replacement tokens for the one or more candidate semantic bias terms.

9. The computing system of claim 8, wherein the syntactic debiased document is previously generated using syntactic debiasing criteria by:
identifying a syntactic bias term in a grammar corrected document;
generating a corresponding non-bias term for the syntactic bias term based on the syntactic debiasing criteria; and
generating the syntactic debiased document by replacing the syntactic bias term with the corresponding non-bias term within the grammar corrected document.

10. The computing system of claim 8, wherein the classification model comprises a machine learning model previously trained on a domain-specific text corpus based on semantic bias criteria that is based on a context of use of the one or more candidate semantic bias terms in the document segment.

11. The computing system of claim 10, wherein the semantic bias criteria defines one or more semantic contexts and one or more bias classifications corresponding to each of the one or more semantic contexts.

12. The computing system of claim 11, wherein providing, using the semantic debiasing model, the one or more replacement tokens for the one or more candidate semantic bias terms comprises:
identifying a subset of document segments; and
generating, using the semantic debiasing model, the one or more replacement tokens for the one or more candidate semantic bias terms based on the subset of document segments.

13. The computing system of claim 8, wherein the one or more replacement tokens are selected from one or more candidate replacement tokens based on comparing the one or more candidate replacement tokens with the semantic bias corpus.

14. The computing system of claim 13, wherein the one or more candidate replacement tokens are generated by:
generating one or more masked tokens corresponding to the one or more candidate semantic bias terms; and
generating, using the semantic debiasing model and based on context information of the document segment, the one or more replacement tokens for the one or more candidate semantic bias terms.

15. One or more non-transitory computer-readable storage media including instructions that, when executed by one or more processors, cause the one or more processors to:
generate one or more document segments that each comprise a sequence of terms from a syntactic debiased document;
identify one or more candidate semantic bias terms from a document segment of the one or more document segments based on a semantic bias corpus;
in response to the identification of the one or more candidate semantic bias terms, generate, using a classification model, a bias classification for the document segment; and
in response to a positive bias classification, provide, using a semantic debiasing model, one or more replacement tokens for the one or more candidate semantic bias terms.

16. The one or more non-transitory computer-readable storage media of claim 15, wherein the syntactic debiased document is previously generated using syntactic debiasing criteria by:
identifying a syntactic bias term in a grammar corrected document;
generating a corresponding non-bias term for the syntactic bias term based on the syntactic debiasing criteria; and
generating the syntactic debiased document by replacing the syntactic bias term with the corresponding non-bias term within the grammar corrected document.

17. The one or more non-transitory computer-readable storage media of claim 15, wherein the classification model comprises a machine learning model previously trained on a domain-specific text corpus based on semantic bias criteria that is based on a context of use of the one or more candidate semantic bias terms in the document segment.

18. The one or more non-transitory computer-readable storage media of claim 17, wherein the semantic bias criteria defines one or more semantic contexts and one or more bias classifications corresponding to each of the one or more semantic contexts.

19. The one or more non-transitory computer-readable storage media of claim 18, wherein providing, using the semantic debiasing model, the one or more replacement tokens for the one or more candidate semantic bias terms comprises:
identifying a subset of document segments; and
generating, using the semantic debiasing model, the one or more replacement tokens for the one or more candidate semantic bias terms based on the subset of document segments.

20. The one or more non-transitory computer-readable storage media of claim 19, wherein the one or more replacement tokens are selected from one or more candidate replacement tokens based on comparing the one or more candidate replacement tokens with the semantic bias corpus.
